(19) United States
(12) Patent Application Publication
(10) Pub. No.: US 2025/0323687 A1
(43) Pub. Date: Oct. 16, 2025

(54) UPLINK NOISE REDUCTION AND SIGNAL-TO-INTERFERENCE-AND-NOISE RATIO (SINR) IMPROVEMENT IN A DISTRIBUTED ANTENNA SYSTEM

(71) Applicant: Outdoor Wireless Networks LLC, Claremont, NC (US)

(72) Inventors: Suresh N. Sriram, Bangalore (IN); Thomas Kummetz, Bayern (DE); Sudarshana Varadappa, Bangalore (IN); Sandeep Dikshit, Bangalore (IN)

(73) Assignee: Outdoor Wireless Networks LLC, Claremont, NC (US)

(21) Appl. No.: 18/867,977

(22) PCT Filed: May 19, 2023
(86) PCT No.: PCT/US2023/022996

§ 371 Date: Nov. 21, 2024

(30) Foreign Application Priority Data
May 21, 2022 (IN) 202241029317

(51) Int. Cl. H04B 7/022; H01Q 1/24

(52) U.S. Cl. CPC H04B 7/022; H01Q 1/246

(57) ABSTRACT

One embodiment is directed to a method of performing uplink combining in a distributed antenna system serving a base station. The distributed antenna system comprises a combining entity and a plurality of source entities communicatively coupled to the combining entity and configured to source uplink user-plane data for the base station to the combining entity. The method comprises performing selection combining for the base station by doing the following: selecting some of the uplink user-plane data sourced from the source entities for the base station; and performing uplink combining using only the selected uplink user-plane data to generate combined uplink user-plane data for the base station. Other embodiments are disclosed.

### CROSS-REFERENCE TO RELATED APPLICATIONS

This application claims the benefit of Indian Provisional Patent Application Serial No. 202241029317, filed on May 21, 2022, which is hereby incorporated herein by reference in its entirety.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote antenna units” or “radio units”), where each access point can be coupled directly to one or more of the central access nodes or indirectly via one or more other remote units and/or via one or more intermediary or expansion units or nodes (also referred to here as “transport expansion nodes (TENs)”). A DAS is typically used to improve the coverage provided by one or more base stations that are coupled to the central access nodes. These base stations can be coupled to the one or more central access nodes via one or more cables or via a wireless connection, for example, using one or more donor antennas. The wireless service provided by the base stations can include commercial cellular service and/or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals that are radiated from one or more coverage antennas associated with that access point. The downlink radio frequency signals are radiated for reception by user equipment (UEs). Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits them to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, this involves, among other things, summing uplink signals received from all of the multiple access points in order to produce the base station signal provided to each base station. In this way, the DAS increases the coverage area for the uplink capacity provided by the base stations.

A DAS can use either digital transport, analog transport, or combinations of digital and analog transport for generating and communicating the transport signals between the central access nodes, the access points, and any transport expansion nodes.

Traditionally, a DAS is operated in a “full simulcast” mode in which downlink signals for each base station are transmitted from multiple access points of the DAS and in which uplink signals for each base station are generated by summing uplink data received from all of the multiple access points. That is, each uplink signal provided to each base station is typically generated by summing uplink data received using all of the multiple access points, even though it is typically the case that for each UE served by the DAS only a few access points of the DAS will typically contribute any meaningful “signal” for that UE and the other access points will typically contribute mostly “noise” for that UE and/or typically contribute mostly “interference” for that UE. Because the number of access points contributing mostly “noise” or “interference” is typically much larger than the number of access points contributing any meaningful “signal,” summing uplink data received using all of the access points typically increases the noise floor in the resulting uplink signal generated for the base station and may reduce the overall signal-to-interference-and-noise ratio (SINR) for the resulting uplink signal.

### SUMMARY

One embodiment is directed to a distributed antenna system serving a base station. The distributed antenna system comprises a combining entity and a plurality of source entities communicatively coupled to the combining entity and configured to source uplink user-plane data for the base station to the combining entity. The distributed antenna system is configured to perform selection combining by doing the following: select some of the uplink data sourced from the source entities for the base station; and perform uplink combining using only the selected uplink user-plane data to generate combined uplink user-plane data for the base station.

Another embodiment is directed to a method of performing uplink combining in a distributed antenna system serving a base station. The distributed antenna system comprises a combining entity and a plurality of source entities communicatively coupled to the combining entity and configured to source uplink user-plane data for the base station to the combining entity. The method comprises performing selection combining for the base station by doing the following: selecting some of the uplink user-plane data sourced from the source entities for the base station; and performing uplink combining using only the selected uplink user-plane data to generate combined uplink user-plane data for the base station.

Other embodiments are disclosed.

The details of various embodiments are set forth in the accompanying drawings and the description below. Other features and advantages will become apparent from the description, the drawings, and the claims.

### BRIEF DESCRIPTION OF DRAWINGS

FIGS. 1A-1C are block diagrams illustrating one exemplary embodiment of a virtualized DAS (vDAS).

FIG. 2 is a block diagram illustrating one exemplary embodiment of an access point that can be used in the vDAS of FIGS. 1A-1C.

FIGS. 3A-3D are block diagrams illustrating one exemplary embodiment of vDAS in which at least some of the APs are coupled to one or more vMU serving them via one or more intermediate combining nodes (ICNs).

FIG. 4 is a block diagram illustrating one exemplary embodiment of vDAS in which one or more physical donor RF interfaces are configured to by-pass the associated vMUs.

FIG. 5 comprises a high-level flowchart illustrating one exemplary embodiment of a method of performing uplink combining in a distributed antenna system.

FIG. 6 comprises a high-level flowchart illustrating one exemplary embodiment of a method of identifying and disabling downlink transport to inactive source entities of a distributed antenna system.

Like reference numbers and designations in the various drawings indicate like elements.

### DETAILED DESCRIPTION

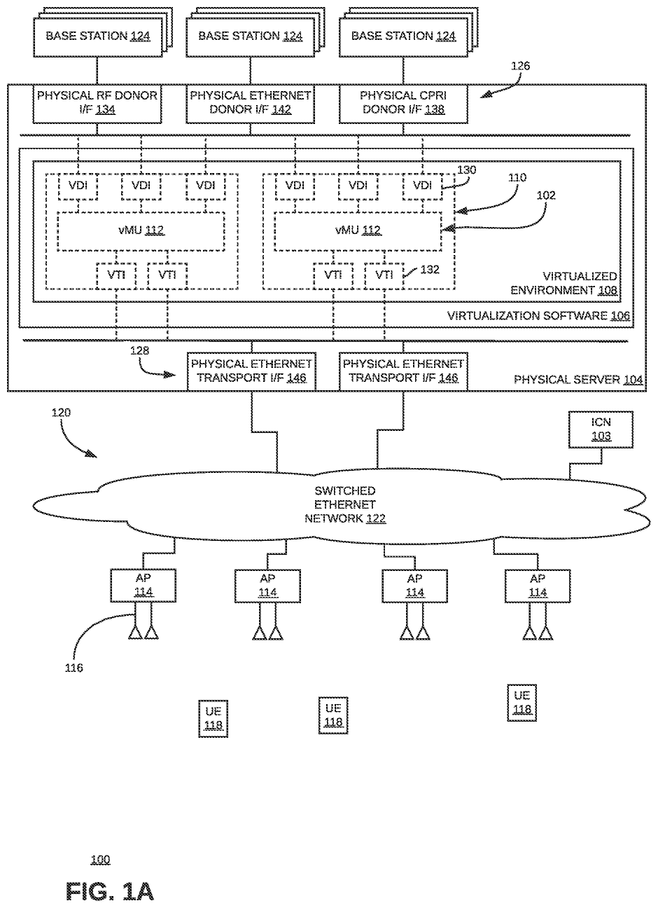

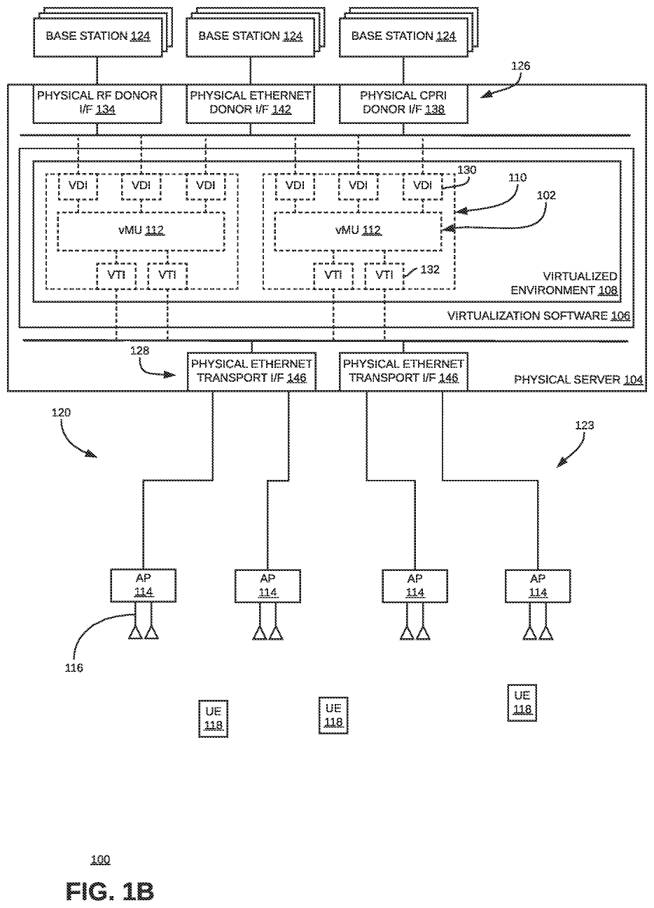

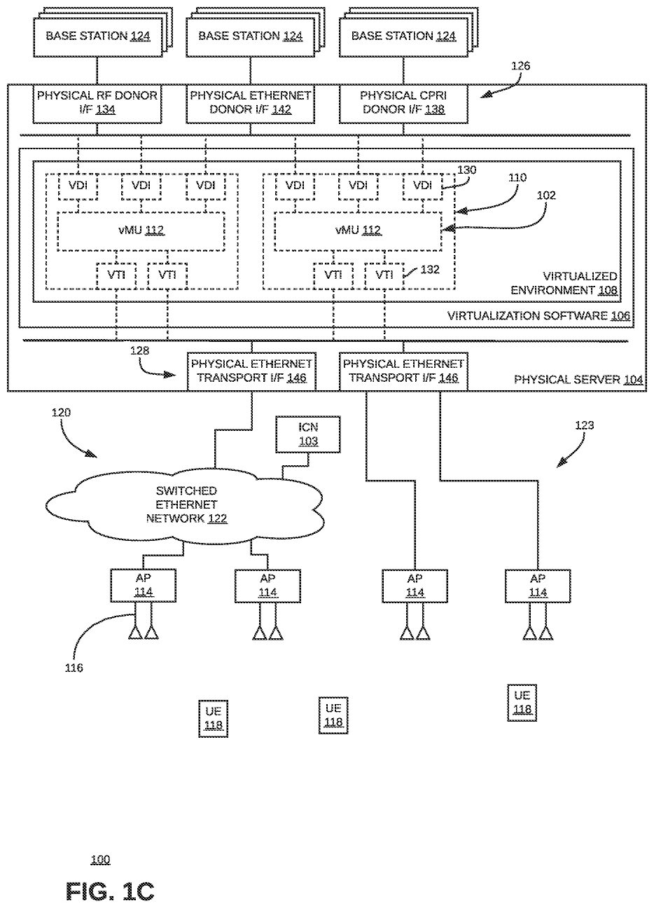

FIGS. 1A-1C are block diagrams illustrating one exemplary embodiment of a virtualized DAS (vDAS) 100. In the exemplary embodiment of the virtualized DAS 100 shown in FIGS. 1A-1C, one or more nodes or functions of a traditional DAS (such as a master unit or CAN) are implemented using one or more virtual network functions (VNFs) 102 executing on one or more physical server computers (also referred to here as “physical servers” or just “servers”) 104 (for example, one or more commercial-off-the-shelf (COTS) servers of the type that are deployed in data centers or “clouds” maintained by enterprises, communication service providers, or cloud services providers).

Each such physical server computer 104 is configured to execute software that is configured to implement the various functions and features described here as being implemented by the associated VNF 102. Each such physical server computer 104 comprises one or more programmable processors for executing such software. The software comprises program instructions that are stored (or otherwise embodied) on or in an appropriate non-transitory storage medium or media (such as flash or other non-volatile memory, magnetic disc drives, and/or optical disc drives) from which at least a portion of the program instructions are read by the respective programmable processor for execution thereby. Both local storage media and remote storage media (for example, storage media that is accessible over a network), as well as removable media, can be used. Each such physical server computer 104 also includes memory for storing the program instructions (and any related data) during execution by the respective programmable processor.

In the example shown in FIGS. 1A-1C, virtualization software 106 is executed on each physical server computer 104 in order to provide a virtualized environment 108 in which one or more one or more virtual entities 110 (such as one or more virtual machines and/or containers) are used to deploy and execute the one or more VNFs 102 of the vDAS 100. In the following description, it should be understood that references to “virtualization” are intended to refer to, and include within their scope, any type of virtualization technology, including “container” based virtualization technology (such as, but not limited to, Kubernetes).

In the example shown in FIGS. 1A-1C, the vDAS 100 comprises at least one virtualized master unit (vMU) 112 and a plurality of access points (APs) (also referred here to as “remote antenna units” (RAUs) or “radio units” (RUs)) 114. Each vMU 112 is configured to implement at least some of the functions normally carried out by a physical master unit or CAN in a traditional DAS.

Each of the vMU 112 is implemented as a respective VNF 102 deployed on one or more of the physical servers 104. Each of the APs 114 is implemented as a physical network function (PNF) and is deployed in or near a physical location where coverage is to be provided.

Each of the APs 114 includes, or is otherwise coupled to, one or more coverage antennas 116 via which downlink radio frequency (RF) signals are radiated for reception by user equipment (UEs) 118 and via which uplink RF signals transmitted from UEs 118 are received. Although only two coverage antennas 116 are shown in FIGS. 1A-1C for ease of illustration, it is to be understood that other numbers of coverage antennas 116 can be used. Each of the APs 114 is communicatively coupled to the respective one or more vMU 112 (and the physical server computers 104 on which the vMUs 112 are deployed) using a fronthaul network 120. The fronthaul network 120 used for transport between each vMU 112 and the APs 114 can be implemented in various ways. Various examples of how the fronthaul network 120 can be implemented are illustrated in FIGS. 1A-1C. In the example shown in FIG. 1A, the fronthaul network 120 is implemented using a switched Ethernet network 122 that is used to communicatively couple each AP 114 to each vMU 112 serving that AP 114. That is, in contrast to a traditional DAS in which each AP is coupled to each CAN serving it using only point-to-point links, in the vDAS 100 shown in FIG. 1A, each AP 114 is coupled to each vMU 112 serving it using at least some shared communication links.

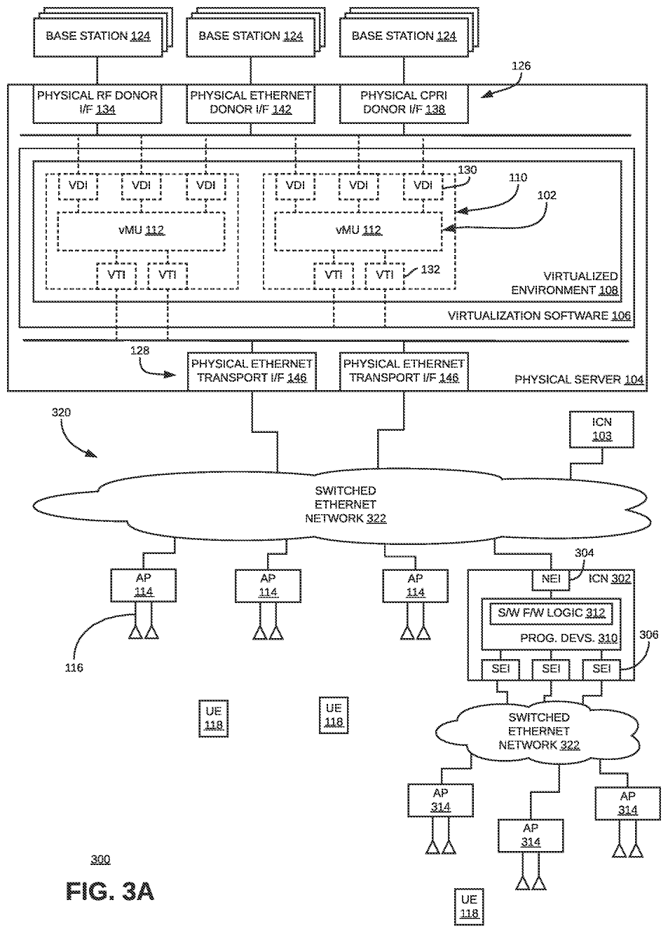

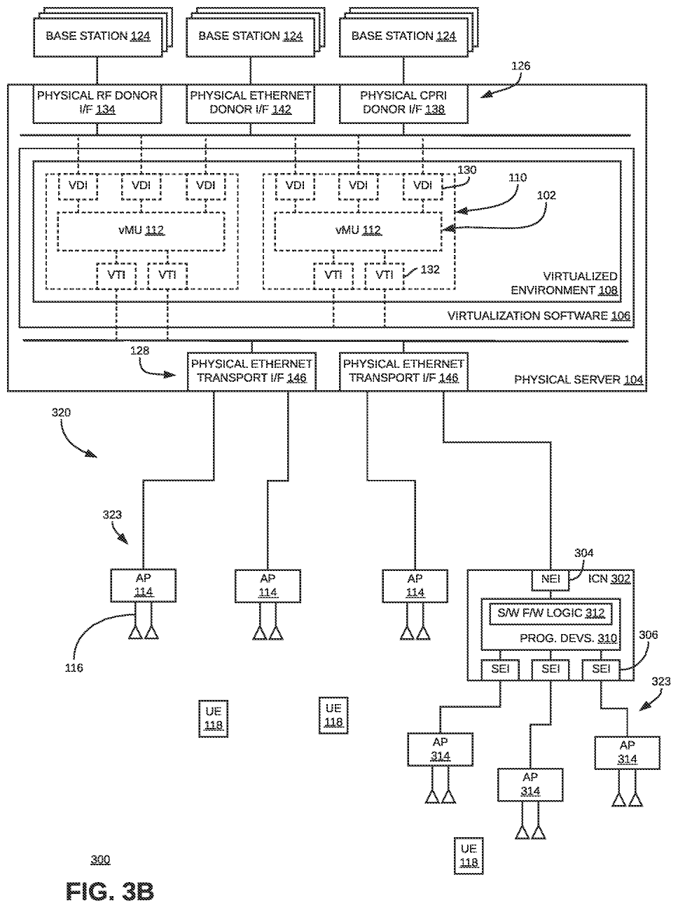

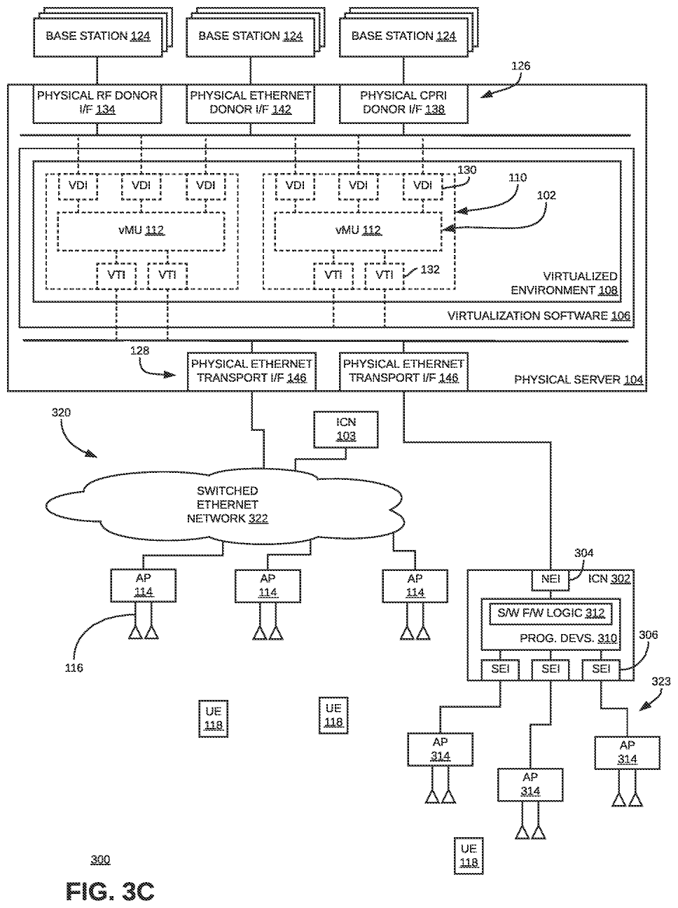

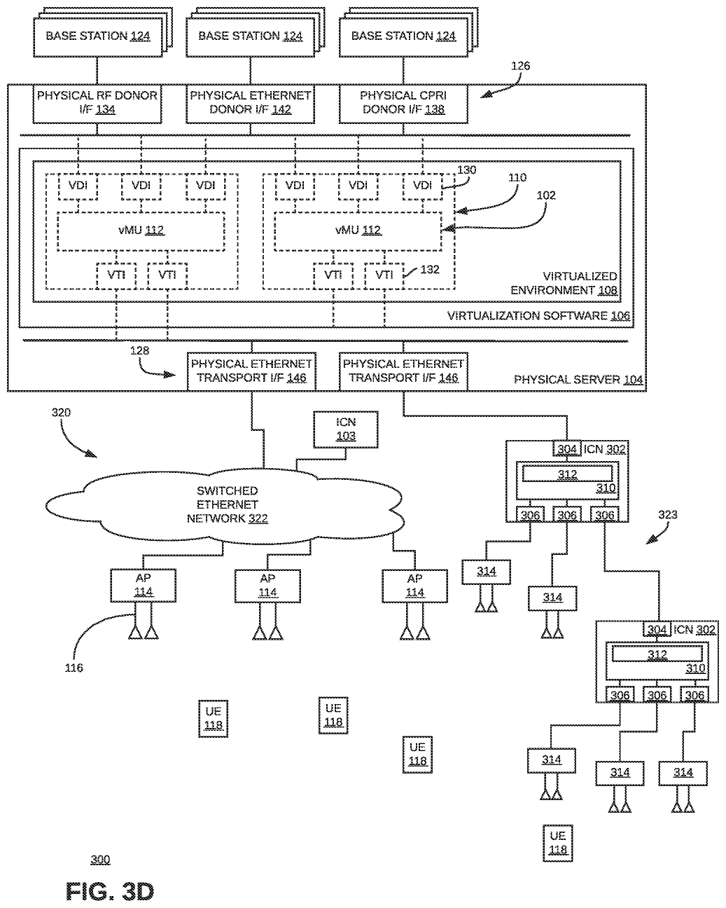

In the example shown in FIG. 1B, the fronthaul network 120 is implemented using only point-to-point Ethernet links 123, where each AP 114 is coupled to each serving vMU 112 serving it via a respective one or more point-to-point Ethernet links 123. In the example shown in FIG. 1C, the fronthaul network 120 is implemented using a combination of a switched Ethernet network 122 and point-to-point Ethernet links 123, where at least one AP 114 is coupled to a vMU 112 serving it at least in part using the switched Ethernet network 122 and at least one AP 114 where at least one AP 114 is coupled to a vMU 112 serving it at least in part using at least one point-to-point Ethernet link 123. FIGS. 3A-3D are block diagrams illustrating other examples in which one or more intermediate combining nodes (ICNs) 302 are used. The examples shown in FIGS. 3A-3D are described below. It is to be understood, however, that FIGS. 1A-1C and 3A-3D illustrate only a few examples of how the fronthaul network (and the vDAS more generally) can be implemented and that other variations are possible.

The vDAS 100 is configured to be coupled to one or more base stations 124 in order to improve the coverage provided by the base stations 124. That is, each base station 124 is configured to provide wireless capacity, whereas the vDAS 100 is configured to provide improved wireless coverage for the wireless capacity provided by the base station 124. As used here, unless otherwise explicitly indicated, references to “base station” include both (1) a “complete” base station that interfaces with the vDAS 100 using the analog radio frequency (RF) interface that would otherwise be used to couple the complete base station to a set of antennas as well as (2) a first portion of a base station 124 (such as a baseband unit (BBU), distributed unit (DU), or similar base station entity) that interfaces with the vDAS 100 using a digital fronthaul interface that would otherwise be used to couple that first portion of the base station to a second portion of the base station (such as a remote radio head (RRH), radio unit (RU), or similar radio entity). In the latter case, different digital fronthaul interfaces can be used (including, for example, a Common Public Radio Interface (CPRI) interface, an evolved CPRI (eCPRI) interface, an IEEE 1914.3 Radio-over-Ethernet (RoE) interface, a functional application programming interface (FAPI) interface, a network FAPI (nFAPI) interface), or an O-RAN fronthaul interface) and different functional splits can be supported (including, for example, functional split 8, functional split 7-2, and functional split 6). The O-RAN Alliance publishes various specifications for implementing RANs in an open manner. (“O-RAN” is an acronym that also stands for “Open RAN,” but in this description references to “O-RAN” should be understood to be referring to the O-RAN Alliance and/or entities or interfaces implemented in accordance with one or more specifications published by the O-RAN Alliance.)

Each base station 124 coupled to the vDAS 100 can be co-located with the vMU 112 to which it is coupled. A co-located base station 124 can be coupled to the vMU 112 to which it is coupled using one or more point-to-point links (for example, where the co-located base station 124 comprises a 4G LTE BBU supporting a CPRI fronthaul interface, the 4G LTE BBU can be coupled to the vMU 112 using one or more optical fibers that directly connect the BBU to the vMU 112) or a shared network (for example, where the co-located base station 124 comprises a DU supporting an Ethernet-based fronthaul interface (such as an O-RAN or eCPRI fronthaul interface), the co-located DU can be coupled to the vMU 112 using a switched Ethernet network). Each base station 124 coupled to the vDAS 100 can also be located remotely from the vMU 112 to which it is coupled. A remote base station 124 can be coupled to the vMU 112 to which it is coupled via a wireless connection (for example, by using a donor antenna to wirelessly couple the remote base station 124 to the vMU 112 using an analog RF interface) or via a wired connection (for example, where the remote base station 124 comprises a DU supporting an Ethernet-based fronthaul interface (such as an O-RAN or eCPRI fronthaul interface), the remote DU can be coupled to the vMU 112 using an Internet Protocol (IP)-based network such as the Internet).

The vDAS 100 described here is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100). For example, multiple vMUs 112 can be instantiated, where a different group of one or more vMUs 112 can be used with each of the wireless service operators (and the base stations 124 of that wireless service operator). The vDAS 100 described here is especially well-suited for use in such deployments because vMUs 112 can be easily instantiated in order to support additional wireless service operators. This is the case even if an additional physical server computer 104 is needed in order to instantiate a new vMU 112 because such physical server computers 104 are either already available in such deployments or can be easily added at a low cost (for example, because of the COTS nature of such hardware). Other vDAS entities implemented in virtualized manner (for example, ICNs) can also be easily instantiated or removed as needed based on demand.

In the example shown in FIGS. 1A-1C, the physical server computer 104 on which each vMU 112 is deployed includes one or more physical donor interfaces 126 that are each configured to communicatively couple the vMU 112 (and the physical server computer 104 on which it is deployed) to one or more base stations 124. Also, the physical server computer 104 on which each vMU 112 is deployed includes one or more physical transport interfaces 128 that are each configured to communicatively couple the vMU 112 (and the physical server computer 104 on which it is deployed) to the fronthaul network 120 (and ultimately the APs 114 and ICNs). Each physical donor interface 126 and physical transport interface 128 is a physical network function (PNF) (for example, implemented as a Peripheral Computer Interconnect Express (PCIe) device) deployed in or with the physical server computer 104.

In the example shown in FIGS. 1A-1C, each physical server computer 104 on which each vMU 112 is deployed includes or is in communication with separate physical donor and transport interfaces 126 and 128; however, it is to be understood that in other embodiments a single set of physical interfaces 126 and 128 can be used for both donor purposes (that is, communication between the vMU 112 to one or more base stations 124) and for transport purposes (that is, communication between the vMU 112 and the APs 114 over the fronthaul network 120).

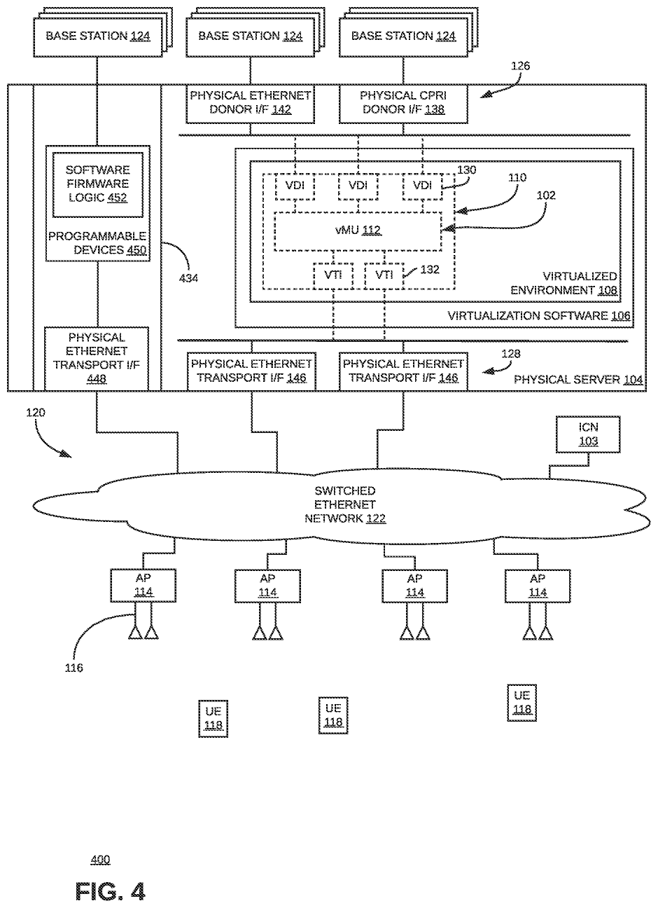

In the exemplary embodiment shown in FIGS. 1A-1C, the physical donor interfaces 126 comprise one or more physical RF donor interfaces (also referred to here as “physical RF donor cards”) 134. Each physical RF donor interface 134 is in communication with one or more vMUs 112 executing on the physical server computer 104 in which that physical RF donor interface 134 is deployed (for example, by implementing the physical RF donor interface 134 as a card inserted in the physical server computer 104 and communicating over a PCIe lane with a central processing unit (CPU) used to execute each such vMU 112). Each physical RF donor interface 134 includes one or more sets of physical RF ports (not shown) to couple the physical RF donor interface 134 to one or more base stations 124 using an analog RF interface. Each physical RF donor interface 134 is configured, for each base station 124 coupled to it, to receive downlink analog RF signals from the base station 124 via respective RF ports, convert the received downlink analog RF signals to digital downlink time-domain user-plane data, and output it to a vMU 112 executing on the same server computer 104 in which that RF donor interface 134 is deployed. Also, each physical RF donor interface 134 is configured, for each base station 124 coupled to it, to receive combined uplink time-domain user-plane data from the vMU 112 for that base station 124, convert the received combined uplink time-domain user-plane data to uplink analog RF signals, and output them to the base station 124. Moreover, the digital downlink time-domain user-plane data produced, and the digital uplink time-domain user-plane data received, by each physical RF donor interface 134 can be in the form of real digital values or complex (that is, in-phase and quadrature (IQ)) digital values and at baseband (that is, centered around 0 Hertz) or with a frequency offset near baseband or an intermediate frequency (IF). Alternatively, as described in more detail below in connection with FIG. 4, one or more of the physical RF donor interfaces can be configured to by-pass the vMU 112 and instead, for the base stations 124 coupled to that physical RF donor interface, have that physical RF donor interface perform some of the functions described here as being performed by the vMU 112 (including the digital combining or summing of user-plane data).

In the exemplary embodiment shown in FIGS. 1A-1C, the physical donor interfaces 126 also comprise one or more physical CPRI donor interfaces (also referred to here as “physical CPRI donor cards”) 138. Each physical CPRI donor interface 138 is in communication with one or more vMUs 112 executing on the physical server computer 104 in which that physical CPRI donor interface 138 is deployed (for example, by implementing the physical CPRI donor interface 138 as a card inserted in the physical server computer 104 and communicating over a PCIe lane with a CPU used to execute each such vMU 112). Each physical CPRI donor interface 138 includes one or more sets of physical CPRI ports (not shown) to couple the physical CPRI donor interface 138 to one or more base stations 124 using a CPRI interface. More specifically, in this example, each base station 124 coupled to the physical CPRI donor interface 138 comprises a BBU or DU that is configured to communicate with a corresponding RRH or RU using a CPRI fronthaul interface. Each physical CPRI donor interface 138 is configured, for each base station 124 coupled to it, to receive from the base station 124 via a CPRI port digital downlink data formatted for the CPRI fronthaul interface, extract the digital downlink data, and output it to a vMU 112 executing on the same server computer 104 in which that CPRI donor interface 138 is deployed. Also, each physical CPRI donor interface 138 is configured, for each base station 124 coupled to it, to receive digital uplink data including combined digital user-plane data from the vMU 112, format it for the CPRI fronthaul interface, and output the CPRI formatted data to the base station 124 via the CPRI ports.

In the exemplary embodiment shown in FIGS. 1A-1C, the physical donor interfaces 126 also comprise one or more physical donor Ethernet interfaces 142. Each physical donor Ethernet interface 142 is in communication with one or more vMUs 112 executing on the physical server computer 104 in which that physical donor Ethernet interface 142 is deployed (for example, by implementing the physical donor Ethernet interface 142 as a card or module inserted in the physical server computer 104 and communicating over a PCIe lane with a CPU used to execute each such vMU 112). Each physical donor Ethernet interface 142 includes one or more sets of physical donor Ethernet ports (not shown) to couple the physical donor Ethernet interface 142 to one or more base stations 124 so that each vMU 112 can communicate with the one or more base stations 124 using an Ethernet-based digital fronthaul interface (for example, an O-RAN or eCPRI fronthaul interface). More specifically, in this example, each base station 124 coupled to the physical donor Ethernet interface 142 comprises a BBU or DU that is configured to communicate with a corresponding RRH or RU using an Ethernet-based fronthaul interface. Each donor Ethernet interface 142 is configured, for each base station 124 coupled to it, to receive from the base station 124 digital downlink fronthaul data formatted as Ethernet data, extract the digital downlink fronthaul data, and output it to a vMU 112 executing on the same server computer 104 in which that donor Ethernet interface 142 is deployed. Also, each physical donor Ethernet interface 142 is configured, for each base station 124 coupled to it, to receive digital uplink fronthaul data including combined digital user-plane data for the base station 124 from the vMU 112, output it to the base station 124 via one or more Ethernet ports 144. In some implementations, each physical donor Ethernet interface 142 is implemented using standard Ethernet interfaces of the type typically used with COTS physical servers.

In the exemplary embodiment shown in FIGS. 1A-1C, the physical transport interfaces 128 comprise one or more physical Ethernet transport interfaces 146. Each physical transport Ethernet interface 146 is in communication with one or more vMUs 112 executing on the physical server computer 104 in which that physical transport Ethernet interface 146 is deployed (for example, by implementing the physical transport Ethernet interface 146 as a card or module inserted in the physical server computer 104 and communicating over a PCIe lane with a CPU used to execute each such vMU 112). Each physical transport Ethernet interface 146 includes one or more sets of Ethernet ports (not shown) to couple the physical transport Ethernet interface 146 to the Ethernet cabling used to implement the fronthaul network 120 so that each vMU 112 can communicate with the various APs 114 and ICNs. In some implementations, each physical transport Ethernet interface 146 is implemented using standard Ethernet interfaces of the type typically used with COTS physical servers.

In this exemplary embodiment, the virtualization software 106 is configured to implement within the virtual environment 108 a respective virtual interface for each of the physical donor interfaces 126 and physical transport Ethernet interfaces 146 in order to provide and control access to the associated physical interface by each vMU 112 implemented within that virtual environment 108. That is, the virtualization software 106 is configured so that the virtual entity 110 used to implement each vMU 112 includes or communicates with a virtual donor interface (VDI) 130 that virtualizes and controls access to the underlying physical donor interface 126. Each VDI 130 can also be configured to perform some donor-related signal or other processing (for example, each VDI 130 can be configured to process the user-plane and/or control-plane data provided by the associated physical donor interface 126 in order to determine timing and system information for the base station 124 and associated cell). Also, although each VDI 130 is illustrated in the examples shown in FIGS. 1A-1C as being separate from the respective vMU 112 with which it is associated, it is to be understood that that each VDI 130 can also be implemented as a part of the vMU 112 with which it is associated. Likewise, the virtualization software 106 is configured so that the virtual entity 110 used to implement each vMU 112 includes or communicates with a virtual transport interface (VTI) 132 that virtualizes and controls access to the underlying physical transport interface 128. Each VTI 132 can also be configured to perform some transport-related signal or other processing. Also, although each VTI 132 is illustrated in the examples shown in FIGS. 1A-1C as being separate from the respective vMU 112 with which it is associated, it is to be understood that that each VTI 132 can also be implemented as a part of the vMU 112 with which it is associated. For each port of each physical Ethernet transport interface 146, the physical Ethernet transport interface 146 (and each corresponding virtual transport interface 132) is configured to communicate over a switched Ethernet network or over a point-to-point Ethernet link depending on how the fronthaul network 120 is implemented (more specifically, depending whether the particular Ethernet cabling connected to that port is being used to implement a part of a switched Ethernet network or is being used to implement a point-to-point Ethernet link).

The vDAS 100 is configured to serve each base station 124 using a respective subset of APs 114 (which may include less than all of the APs 114 of the vDAS 100). The subset of APs 114 used to serve a given base station 124 is also referred to here as the “simulcast zone” for that base station 124. Typically, the simulcast zone for each base station 124 includes multiple APs 114. In this way, the vDAS 100 increases the coverage area for the capacity provided by the base stations 124. Different base stations 124 (including different base stations 124 from different wireless service operators in deployments where multiple wireless service operators share the same vDAS 100) can have different simulcast zones defined for them. Also, the simulcast zone for each served base station 124 can change (for example, based on a time of day, day of week, etc., and/or in response to a particular condition or event).

In general, the wireless coverage of a base station 124 served by the vDAS 100 is improved by radiating a set of downlink RF signals for that base station 124 from the coverage antennas 116 associated with the multiple APs 114 in that base station's simulcast zone and by producing a single set of uplink base station signals by a combining or summing process that uses inputs derived from the uplink RF signals received via the coverage antennas 116 associated with the multiple APs 114 in that base station's simulcast zone, where the resulting final single set of uplink base station signals is provided to the base station 124.

This combining or summing process can be performed in a centralized manner in which the combining or summing process for each base station 124 is performed by a single unit of the vDAS 100 (for example, by the associated vMU 112). This combining or summing process can also be performed for each base station 124 in a distributed or hierarchical manner in which the combining or summing process is performed by multiple units of the vDAS 100 (for example, the associated vMU 112 and one or more ICNs and/or APs 114). Each unit of the vDAS 100 that performs the combining or summing process for a given base station 124 receives uplink transport data for that base station 124 from that unit's one or more “southbound” entities, combines or sums corresponding user-plane data contained in the received uplink transport data for that base station 124 as well as any corresponding user-plane data generated at that unit from uplink RF signals received via coverage antennas 116 associated with that unit (which would be the case if the unit is a “daisy-chained” AP 114), generates uplink transport data containing the combined user-plane data for that base station 124, and communicates the resulting uplink transport data for that base station 124 to the appropriate “northbound” entities coupled to that unit. As used here, “southbound” refers to traveling in a direction “away,” or being relatively “farther,” from the vMU 112 and base station 124, and “northbound” refers to traveling in a direction “towards”, or being relatively “closer” to, the vMU 112 and base station 124. As used here, the southbound entities of a given unit are those entities that are subtended from that unit in the southbound direction, and the northbound entities of a given unit are those entities from which the given unit is itself subtended from in the southbound direction.

The vDAS 100 can also include one or more intermediary or intermediate combining nodes (ICNs) (also referred to as “expansion” units or nodes). For each base station 124 that the vDAS 100 serves using an ICN, the ICN is configured to receive a set of uplink transport data containing user-plane data for that base station 124 from a group of southbound entities (that is, from APs 114 and/or other ICNs) and perform the uplink combining or summing process described above in order to generate uplink transport data containing combined user-plane data for that base station 124, which the ICN transmits northbound towards the vMU 112 serving that base station 124. Each ICN also forwards northbound all other uplink transport data (for example, uplink management-plane and synchronization-plane data) received from its southbound entities. In the embodiments shown in FIGS. 1A, 1C, 3A, 3C, and 3D, the ICN 103 is communicatively coupled to its northbound entities and its southbound entities using the switched Ethernet network 122 and is used only for communicating uplink transport data and is not used for communicating downlink transport data. In such embodiments, each ICN 103 includes one or more Ethernet interfaces to communicatively couple the ICN 103 to the switched Ethernet network 122. For example, the ICN 103 can include one or more Ethernet interfaces that are used for communicating with its northbound entities and one or more Ethernet interfaces that are used for communicating with its southbound entities. Alternatively, the ICN 103 can communicate with both its northbound and southbound entities via the switched Ethernet network 122 using the same set of one or more Ethernet interfaces.

In some embodiments, the vDAS 100 is configured so that some ICNs also communicate (forward) southbound downlink transport data received from their northbound entities (in addition to communicating uplink transport data). In the embodiments shown in FIGS. 3A-3D, the ICNs 302 are used in this way. The ICNs 302 are communicatively coupled to their northbound entities and their southbound entities using point-to-point Ethernet links 123 and are used for communicating both uplink transport data and downlink transport data.

Generally, ICNs can be used to increase the number of APs 114 that can be served by a vMU 112 while reducing the processing and bandwidth load relative to having the additional APs 114 communicate directly with the vMU 112. Each ICN can be implemented as a physical network function using dedicated, special-purpose hardware. Alternatively, each ICN can be implemented as a virtual network function running on a physical server. For example, each ICN can be implemented in the same manner as the vMU 112.

Also, one or more APs 114 can be configured in a “daisy-chain” or “ring” configuration in which transport data for at least some of those APs 114 is communicated via at least one other AP 114. Each such AP 114 would also perform the user-plane combining or summing process described above for any base station 124 served by that AP 114 in order to combine or sum user-plane data generated at that AP 114 from uplink RF signals received via its associated coverage antennas 116 with corresponding uplink user-plane data for that base station 124 received from any southbound entity subtended from that AP 114. Such an AP 114 also forwards northbound all other uplink transport data received from any southbound entity subtended from it and forwards to any southbound entity subtended from it all downlink transport received from its northbound entities.

In general, the vDAS 100 is configured to receive a set of downlink base station signals from each served base station 124, generate downlink base station data for the base station 124 from the set of downlink base station signals, generate downlink transport data for the base station 124 that is derived from the downlink base station data for the base station 124, and communicate the downlink transport data for the base station 124 over the fronthaul network 120 of the vDAS 100 to the APs 114 in the simulcast zone of the base station 124. Each AP 114 in the simulcast zone for each base station 124 is configured to receive the downlink transport data for that base station 124 communicated over the fronthaul network 120 of the vDAS 100, generate a set of downlink analog radio frequency (RF) signals from the downlink transport data, and wirelessly transmit the set of downlink analog RF signals from the respective set of coverage antennas 116 associated with that AP 114. The downlink analog RF signals are radiated for reception by UEs 118 served by the base station 124. As described above, the downlink transport data for each base station 124 can be communicated to each AP 114 in the base station's simulcast zone via one or more intermediary units of the vDAS 100 (such as one or more ICNs or daisy-chained APs 114). Also as described above, if an AP 114 is a part of a daisy chain, the AP 114 will also forward to any southbound entity subtended from that AP 114 all downlink transport received from its northbound entities.

The vDAS 100 is configured so that a vMU 112 associated with at least one base station 124 performs at least some of the processing related to generating the downlink transport data that is derived from the downlink base station data for that base station 124 and communicating the downlink transport data for the base station 124 over the fronthaul network 120 of the vDAS 100 to the APs 114 in the simulcast zone of the base station 124. In exemplary embodiments shown in FIGS. 1A-1C, a respective vMU 112 does this for all of the served base stations 124.

In general, each AP 114 in the simulcast zone of a base station 124 receives one or more uplink RF signals transmitted from UEs 118 being served the base station 124. Each such AP 114 generates uplink transport data derived from the one or more uplink RF signals and transmits it over the fronthaul network 120 of the vDAS 100. As noted above, as a part of doing this, if the AP 114 is a part of daisy chain, the AP 114 performs the user-plane combining or summing process described above for the base station 124 in order to combine or sum user-plane data generated at that AP 114 from uplink RF signals received via its associated coverage antennas 116 for the base station 124 with any corresponding uplink user-plane data for that base station 124 received from any southbound entity subtended from that AP 114. Such a daisy-chained AP 114 also forwards northbound to its northbound entities all other uplink transport data received from any southbound entity subtended from that AP 114. As described above, the uplink transport data for each base station 124 can be communicated from each AP 114 in the base station's simulcast zone over the fronthaul network 120 via one or more intermediary units of the vDAS 100 (such as one or more ICNs or daisy-chained APs 114).

The vDAS 100 is configured to receive uplink transport data for each base station 124 from the fronthaul network 120 of the vDAS 100, use the uplink transport data for the base station 124 received from the fronthaul network 120 of the vDAS 100 to generate uplink base station data for the base station 124, generate a set of uplink base station signals from the uplink base station data for the base station 124, and provide the uplink base station signals to the base station 124. As a part of doing this, the user-plane combining or summing process can be performed for the base station 124.

The vDAS 100 is configured so that a vMU 112 associated with at least one base station 124 performs at least some of the processing related to using the uplink transport data for the base station 124 received from the fronthaul network 120 of the vDAS 100 to generate the uplink base station data for the base station 124. In exemplary embodiments shown in FIGS. 1A-1C, a respective vMU 112 does this for all of the served base stations 124. As a part of performing this processing, the vMU 112 can perform at least some of the user-plane combining or summing process for the base station 124.

Also, for any base station 124 coupled to the vDAS 100 using a CPRI fronthaul interface or an Ethernet fronthaul interface, the associated vMU 112 (and/or VDI 132 or physical donor interface 126) is configured to appear to that base station 124 (that is, the associated BBU or DU) as a single RU or RRH of the type that the base station 124 is configured to work with (for example, as a CPRI RU or RRH where the associated BBU or DU is coupled to the vDAS 100 using a CPRI fronthaul interface or as an O-RAN, eCPRI, or RoE RU or RRH where the associated BBU or DU is coupled to the vDAS 100 using an O-RAN, eCPRI, or RoE fronthaul interface). As a part of doing this, the vMU 112 (and/or VDI 132 or physical donor interface 126) is configured to implement the control-plane, user-plane, synchronization-plane, and management-plane functions that such a RU or RRU would implement. Stated another way, in this example, the vMU 112 (and/or VDI 132 or physical donor interface 126) is configured to implement a single “virtual” RU or RRH for the associated base station 124 even though multiple APs 114 are actually being used to wirelessly transmit and receive RF signals for that base station 124.

In some implementations, the content of the transport data and the manner it is generated depend on the functional split and/or fronthaul interface used to couple the associated base station 124 to the vDAS 100 and, in other implementations, the content of the transport data and the manner in which it is generated is generally the same for all donor base stations 124, regardless of the functional split and/or fronthaul interface used to couple each donor base station 124 to the vDAS 100. More specifically, in some implementations, whether user-plane data is communicated over the vDAS 100 as time-domain data or frequency-domain data depends on the functional split used to couple the associated donor base station 124 to the vDAS 100. That is, where the associated donor base station 124 is coupled to the vDAS 100 using functional split 7-2 (for example, where the associated donor base station 124 comprises an O-RAN DU that is coupled to the vDAS 100 using the O-RAN fronthaul interface), transport data communicated over the fronthaul network 120 of the vDAS 100 comprises frequency-domain user-plane data and any associated control-plane data. Where the associated donor base station 124 is coupled to the vDAS 100 using functional split 8 (for example, where the associated donor base station 124 comprises a CPRI BBU that is coupled to the vDAS 100 using the CPRI fronthaul interface) or where the associated donor base station 124 is coupled to the vDAS 100 using an analog RF interface (for example, where the associated donor base station 124 comprises a “complete” base station that is coupled to the vDAS 100 using the analog RF interface that otherwise be used to couple the antenna ports of the base station to a set of antennas), transport data communicated over the fronthaul network 120 of the vDAS 100 comprises time-domain user-plane data and any associated control-plane data.

In some implementations, user-plane data is communicated over the vDAS 100 in one form (either as time-domain data or frequency-domain data) regardless of the functional split used to couple the associated donor base station 124 to the vDAS 100. For example, in some implementations, user-plane data is communicated over the vDAS 100 as frequency-domain data regardless of the functional split used to couple the associated donor base station 124 to the vDAS 100. Alternatively, user-plane data can be communicated over the vDAS 100 as time-domain data regardless of the functional split used to couple the associated donor base station 124 to the vDAS 100. In implementations where user-plane data is communicated over the vDAS 100 in one form, user plane data is converted as needed (for example, by converting time-domain user plane data to frequency-domain user plane data and generating associated control plane data or by converting frequency-domain user plane data to time-domain user plane data and generating associated control plane data as needed).

In some such implementations, the same fronthaul interface can be used for transport data communicated over the fronthaul network 120 of the vDAS 100 for all the different types of donor base stations 124 coupled to the vDAS 100. For example, in implementations where user-plane data is communicated over the vDAS 100 in different forms, the O-RAN fronthaul interface can be used for transport data used to communicate frequency-domain user-plane data and any associated control-plane data for donor base stations 124 that are coupled to the vDAS 100 using functional split 7-2 and the O-RAN fronthaul interface can also be used for transport data used to communicate time-domain user-plane data and any associated control-plane data for donor base stations 124 that are coupled to the vDAS 100 using functional split 8 or using an analog RF interface. Also, in implementations where user-plane data is communicated over the vDAS 100 in one form (for example, as frequency-domain data), the O-RAN fronthaul interface can be used for all donor base stations 124 regardless of the functional split used to couple the associated donor base station 124 to the vDAS 100.

Alternatively, in some such implementations, different fronthaul interfaces can be used to communicate transport data for different types of donor base stations 124. For example, the O-RAN fronthaul interface can be used for transport data used to communicate frequency-domain user-plane data and any associated control-plane data for donor base stations 124 that are coupled to the vDAS 100 using functional split 7-2 and a proprietary fronthaul interface can be used for transport data used to communicate time-domain user-plane data and any associated control-plane data for donor base stations 124 that are coupled to the vDAS 100 using functional split 8 or using an analog RF interface.

In some implementations, transport data is communicated in different ways over different portions of the fronthaul network 120 of the vDAS 100. For example, the way transport data is communicated over portions of the fronthaul network 120 of the vDAS 100 implemented using switched Ethernet networking can differ from the way transport data is communicated over portions of the fronthaul network 120 of the vDAS 100 implemented using point-to-point Ethernet links 123 (for example, as a described below in connection with FIGS. 3A-3D).

In the exemplary embodiment shown in FIGS. 1A-1C, the vDAS 100, and each vMU 112, ICN, and AP 114 thereof, is configured to use a time synchronization protocol (for example, the Institute of Electrical and Electronics Engineers (IEEE) 1588 Precision Time Protocol (PTP) or the Synchronous Ethernet (SyncE) protocol) to synchronize itself to a timing master entity established for the vDAS 100. In one example, one of the vMUs 112 is configured to serve as the timing master entity for the vDAS 100 and each of the other vMUs 112 and the ICNs and APs 114 synchronizes itself to that timing master entity. In another example, a separate external timing master entity is used and each vMU 112, ICN, and AP 114 synchronizes itself to that external timing master entity.

In the exemplary embodiment shown in FIGS. 1A-1C, each vMU 112 (and/or the associated VDIs 130) can also be configured to process the downlink user-plane and/or control-plane data for each donor base station 124 in order to determine timing and system information for the donor base station 124 and associated cell. This can involve processing the downlink user-plane and/or control-plane data for the donor base station 124 to perform the initial cell search processing a UE would typically perform in order to acquire time, frequency, and frame synchronization with the base station 124 and associated cell and to detect the Physical layer Cell ID (PCI) and other system information for the base station 124 and associated cell (for example, by detecting and/or decoding the Primary Synchronization Signal (PSS), the Secondary Synchronization Signal (SSS), the Physical Broadcast Channel (PBCH), the Master Information Block (MIB), and System Information Blocks (SIBs)). This timing and system information for a donor base station 124 can be used, for example, to configure the operation of the vDAS 100 (and the components thereof) in connection with serving that donor base station 124.

In order to reduce the latency associated with implementing each vMU 112 or ICN in a virtualized environment 108 running on a COTS physical server 104, input-output (IO) operations associated with communicating data between a vMU 112 and a physical donor interface 126 and/or between a vMU 112 and a physical transport interface 128, as well as any baseband processing performed by a vMU 112, associated VDI 130, or ICN can be time-sliced to ensure that such operations are performed in a timely manner. With such an approach, the tasks and threads associated with such operations and processing are executed in dedicated times slices without such tasks and threads being preempted by, or otherwise having to wait for the completion of, other tasks or threads.

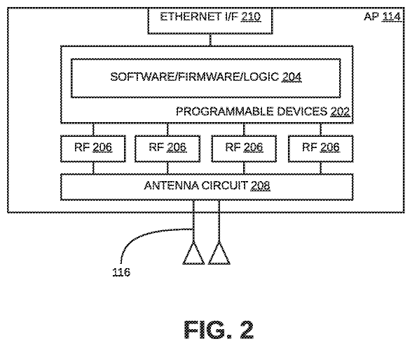

FIG. 2 is a block diagram illustrating one exemplary embodiment of an access point 114 that can be used in the vDAS 100 of FIGS. 1A-1C.

The AP 114 comprises one or more programmable devices 202 that execute, or are otherwise programmed or configured by, software, firmware, or configuration logic 204 in order to implement at least some functions described here as being performed by the AP 114 (including, for example, physical layer (Layer 1) baseband processing described here as being performed by a radio unit (RU) entity implemented using that AP 114). The one or more programmable devices 202 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way. In general, the programmable devices 202 and software, firmware, or configuration logic 204 are scaled so as to be able implement multiple logical (or virtual) RU entities using the (physical) AP 114. The various functions described here as being performed by an RU entity are implemented by the programmable devices 202 and one or more of the RF modules 206 (described below) of the AP 114.

In general, each RU entity implemented by an AP 114 is associated with, and serves, one of the base stations 124 coupled to the vDAS 100. The RU entity communicates transport data with each vMU 112 serving that AP 114 using the particular fronthaul interface used for communicating over the fronthaul network 120 for the associated type of base station 124 and is configured to implement the associated fronthaul interface related processing (for example, formatting data in accordance with the fronthaul interface and implementing control-plane, management-plane, and synchronization-plane functions). The O-RAN fronthaul interface is used in some implementations of the exemplary embodiment described here in connection with FIGS. 1A-1C and 2. In addition, the RU entity performs any physical layer baseband processing that is required to be performed in the RU.

Normally, when a functional split 7-2 is used, some physical layer baseband processing is performed by the DU or BBU and the remaining physical layer baseband processing and the RF functions are performed by the corresponding RU. The physical layer baseband processing performed by the DU or BBU is also referred to as the “high” physical layer baseband processing, and the baseband processing performed by the RU is also referred to as the “low” physical layer baseband processing.

As noted above, in some implementations, the content of the transport data communicated between each AP 114 and a serving vMU 112 depends on the functional split used by the associated base station 124. That is, where the associated base station 124 comprises a DU or BBU that is configured to use a functional split 7-2, the transport data comprises frequency-domain user plane data (and associated control-plane data) and the RU entity for that base station 124 performs the low physical layer baseband processing and the RF functions in addition to performing the processing related to communicating the transport data over the fronthaul network 120 of the vDAS 100. Where the associated base station 124 comprises a DU or BBU that is configured to use functional split 8 or a where the associated base station 124 comprises a “complete” base station that is coupled to a vMU 112 using an analog RF interface, the transport data comprises time-domain user plane data (and associated control-plane data) and the RU entity for that base station 124 performs the RF functions for the base station 124 in addition to performing the processing related to communicating the transport data over the fronthaul network 120 of the vDAS 100.

It is possible for a given AP 114 to communicate and process transport data for different base stations 124 served by that AP 114 in different ways. For example, a given AP 114 may serve a first base station 124 that uses functional split 7-2 and a second base station 124 that uses functional split 8, in which case the corresponding RU entity implemented in that AP 114 for the first base station 124 performs the low physical layer processing for the first base station 124 (including, for example, the inverse fast Fourier transform (iFFT) processing for the downlink data and the fast Fourier transform (FFT) processing for the uplink data), whereas the corresponding RU entity implemented in the AP 114 for the second base station 124 does not perform such low physical layer processing for the second base station 124.

In other implementations, the content of the transport data communicated between each AP 114 and each serving vMU 112 is the same regardless of the functional split used by the associated base station 124. For example, in one such implementation, the transport data communicated between each AP 114 and a serving vMU 112 comprises frequency-domain user plane data (and associated control-plane data), regardless of the functional split used by the associated base station 124. In such implementations, the vMU 112 converts the user plane data as needed (for example, by converting the time-domain user plane data to frequency-domain user-plane data and generating associated control-plane data).

In general, the physical layer baseband processing required to be performed by an RU entity for a given served base station 124 depends on the functional split used for the transport data.

In the exemplary embodiment shown in FIG. 2, the AP 114 comprises multiple radio frequency (RF) modules 206. Each RF module 206 comprises circuitry that implements the RF transceiver functions for a given RU entity implemented using that physical AP 114 and provides an interface to the coverage antennas 116 associated with that AP 114. Each RF module 206 can be implemented using one or more RF integrated circuits (RFICs) and/or discrete components.

Each RF module 206 comprises circuitry that implements, for the associated RU entity, a respective downlink and uplink signal path for each of the coverage antennas 116 associated with that physical AP 114. In one exemplary implementation, each downlink signal path receives the downlink baseband IQ data output by the one or more programmable devices 202 for the associated coverage antenna 116, converts the downlink baseband IQ data to an analog signal (including the various physical channels and associated sub carriers), upconverts the analog signal to the appropriate RF band (if necessary), and filters and power amplifies the analog RF signal. (The up-conversion to the appropriate RF band can be done directly by the digital-to-analog conversion process outputting the analog signal in the appropriate RF band or via an analog upconverter included in that downlink signal path.) The resulting amplified downlink analog RF signal output by each downlink signal path is provided to the associated coverage antenna 116 via an antenna circuit 208 (which implements any needed frequency-division duplexing (FDD) or time-division-duplexing (TDD) functions) including filtering and combining.

In one exemplary implementation, the uplink RF analog signal (including the various physical channels and associated sub carriers) received by each coverage antenna 116 is provided, via the antenna circuit 208, to an associated uplink signal path in each RF module 206.

Each uplink signal path in each RF module 206 receives the uplink RF analog received via the associated coverage antenna 116, low-noise amplifies the uplink RF analog signal, and, if necessary, filters and, if necessary, down-converts the resulting signal to produce an intermediate frequency (IF) or zero IF version of the signal.

Each uplink signal path in each RF module 206 converts the resulting analog signals to real or IQ digital samples and outputs them to the one or more programmable logical devices 202 for uplink signal processing. (The analog-to-digital conversion process can be implemented using a direct RF ADC that can receive and digitize RF signals, in which case no analog down-conversion is necessary.)

Also, in this exemplary embodiment, for each coverage antenna 116, the antenna circuit 208 is configured to combine (for example, using one or more band combiners) the amplified analog RF signals output by the appropriate downlink signal paths of the various RF modules 206 for transmission using each coverage antenna 116 and to output the resulting combined signal to that coverage antenna 116. Likewise, in this exemplary embodiment, for each coverage antenna 116, the antenna circuit 208 is configured to split (for example, using one or more band filter and/or RF splitters) the uplink analog RF signals received using that coverage antenna 116 in order to supply, to the appropriate uplink signal paths of the RF modules 206 used for that antenna 116, a respective uplink analog RF signals for that signal path.

It is to be understood that the preceding description is one example of how each downlink and uplink signal path of each RF module 206 can be implemented; it is to be understood, however, that the downlink and uplink signal paths can be implemented in other ways.

The AP 114 further comprises at least one Ethernet interface 210 that is configured to communicatively couple the AP 114 to the fronthaul network 120 and, ultimately, to the vMU 112. For each port of each Ethernet interface 210, the Ethernet 210 is configured to communicate over a switched Ethernet network or over a point-to-point Ethernet link depending on how the fronthaul network 120 is implemented (more specifically, depending whether the particular Ethernet cabling connected to that port is being used to implement a part of a switched Ethernet network or is being used to implement a point-to-point Ethernet link).

In one example of the operation of the vDAS 100 of FIGS. 1A-1C and 2, each base station 124 coupled to the vDAS 100 is served by a respective set of APs 114. As noted above, the set of APs 114 serving each base station 124 is also referred to here as the “simulcast zone” for that base station 124 and different base stations 124 (including different base stations 124 from different wireless service operators in deployments where multiple wireless service operators share the same vDAS 100) can have different simulcast zones defined for them.

In the downlink direction, one or more downlink base station signals from each base station 124 are received by a physical donor interface 126 of the vDAS 100, which generates downlink base station data using the received downlink base station signals and provides the downlink base station data to the associated vMU 112.

The form that the downlink base station signals take and how the downlink base station data is generated from the downlink base station signals depends on how the base station 124 is coupled to the vDAS 100.

For example, where the base station 124 is coupled to the vDAS 100 using an analog RF interface, the base station 124 is configured to output from its antenna ports a set of downlink analog RF signals. Thus, in this example, the one or more downlink base station signals comprise the set of downlink analog RF signals output by the base station 124 that would otherwise be radiated from a set of antennas coupled to the antenna ports of the base station 124. In this example, the physical donor interface 126 used to receive the downlink base station signals comprises a physical RF donor interface 134. Each of the downlink analog RF signals is received by a respective RF port of the physical RF donor interface 134 installed in the physical server computer 104 executing the vMU 112. The physical RF donor interface 134 is configured to receive each downlink analog RF signal (including the various physical channels and associated sub carriers) output by the base station 124 and generate the downlink base station data by generating corresponding time-domain baseband in-phase and quadrature (IQ) data from the received download analog RF signals (for example, by performing an analog-to-digital (ADC) and digital down conversion process on the received downlink analog RF signal). The generated downlink base station data is provided to the vMU 112 (for example, by communicating it over a PCIe lane to a CPU used to execute the vMU 112).

In another example, the base station 124 comprises a BBU or DU that is coupled to the vDAS 100 using a CPRI fronthaul interface. In this example, the one or more downlink base station signals comprise the downlink CPRI fronthaul signal output by the base station 124 that would otherwise be communicated over a CPRI link to a RU. In this example, the physical donor interface 126 used to receive the one or more downlink base station signals comprises a physical CPRI donor interface 138. Each downlink CPRI fronthaul signal is received by a CPRI port of the physical CPRI donor interface 138 installed in the physical server computer 104 executing the vMU 112. The physical CPRI donor interface 138 is configured to receive each downlink CPRI fronthaul signal, generate downlink base station data by extracting various information flows that are multiplexed together in CPRI frames or messages that are communicated via the downlink CPRI fronthaul signal, and provide the generated downlink base station data to the vMU 112 (for example, by communicating it over a PCIe lane to a CPU used to execute the vMU 112). The extracted information flows can comprise CPRI user-plane data, CPRI control-and-management-plane data, and CPRI synchronization-plane data. That is, in this example, the downlink base station data comprises the various downlink information flows extracted from the downlink CPRI frames received via the downlink CPRI fronthaul signals. Alternatively, the downlink base station data can be generated by extracting downlink CPRI frames or messages from each received downlink CPRI fronthaul signal, where the extracted CPRI frames are provided to the vMU 112 (for example, by communicating them over a PCIe lane to a CPU used to execute the vMU 112).

In another example, the base station 124 comprises a BBU or DU that is coupled to the vDAS 100 using an Ethernet fronthaul interface (for example, an O-RAN, eCPRI, or RoE fronthaul interface). In this example, the one or more downlink base station signals comprise the downlink Ethernet fronthaul signals output by the base station 124 (that is, the BBU or DU) that would otherwise be communicated over an Ethernet network to a RU. In this example, the physical donor interface 126 used to receive the one or more downlink base station signals comprises a physical Ethernet donor interface 142. The physical Ethernet donor interface 142 is configured to receive the downlink Ethernet fronthaul signals, generate the downlink base station data by extracting the downlink messages communicated using the Ethernet fronthaul interface, and provide the messages to the vMU 112 (for example, by communicating them over a PCIe lane to a CPU used to execute the vMU 112). That is, in this example, the downlink base station data comprises the downlink messages extracted from the downlink Ethernet fronthaul signals.

The vMU 112 generates downlink transport data using the received downlink base station data and communicates, using a physical transport Ethernet interface 146, the downlink transport data from the vMU 112 over the fronthaul network 120 to the set of APs 114 serving the base station 124. As described above, the downlink transport data for each base station 124 can be communicated to each AP 114 in the base station's simulcast zone via one or more intermediary units of the vDAS 100 (such as one or more ICNs or daisy-chained APs 114).

The downlink transport data generated for a base station 124 is communicated by the vMU 112 over the fronthaul network 120 so that downlink transport data for the base station 124 is received at the APs 114 included in the simulcast zone of that base station 124. In one example, a multicast group is established for each different simulcast zone assigned to any base station 124 coupled to the vDAS 100. In such an example, the vMU 112 communicates the downlink transport data to the set of APs 114 serving the base station 124 by using one or more of the physical transport Ethernet interfaces 146 to transmit the downlink transport data as transport Ethernet packets addressed to the multicast group established for the simulcast zone associated with that base station 124. In this example, the vMU 112 is configured so that a part of the process of generating the downlink transport data includes formatting the transport Ethernet packets to use the address of the multicast group established for that simulcast zone. In another example, a separate virtual local area network (VLAN) is established for each different simulcast zone assigned to any base station 124 coupled to the vDAS 100, where only the APs 114 included in the associated simulcast zone and the associated vMUs 112 communicate data using that VLAN. In such an example, each vMU 112 is configured so that a part of the process of generating the downlink transport data includes formatting the transport Ethernet packets to be communicated with the VLAN established for that simulcast zone.

In another example, the vMU 112 broadcasts the downlink transport data to all of APs 114 of the vDAS 100 and each AP 114 is configured to determine if any downlink transport data it receives is intended for it. In this example, this can be done by including in the downlink transport data broadcast to the APs 114 a bitmap field that includes a respective bit position for each AP 114 included in the vDAS 100. Each bit position is set to one value (for example, a “1”) if the associated downlink transport data is intended for that AP 114 and is set to a different value (for example, a “0”) if the associated downlink transport data is not intended for that AP 114. In one such example, the bitmap is included in a header portion of the underlying message so that the AP 114 does not need to decode the entire message in order to determine if the associated message is intended for it or not. In one implementation where the O-RAN fronthaul interface is used for the transport data, this can be done using an O-RAN section extension that is defined to include such a bitmap field in the common header fields. In this example, the vMU 112 is configured so that a part of the process of generating the downlink transport data includes formatting the downlink transport data to include a bitmap field, where the bit position for each AP 114 included in the base station's simulcast zone is set to the value (for example, a “1”) indicating that the data is intended for it and where the bit position for each AP 114 not included in the base station's simulcast zone is set to the other value (for example, a “0”) indicating that the data is not intended for it.

As a part of generating the downlink transport data, the vMU 112 performs any needed re-formatting or conversion of the received downlink base station data in order for it to comply with the format expected by the APs 114 or for it to be suitable for use with the fronthaul interface used for communicating over the fronthaul network 120 of the vDAS 100. For example, in one exemplary embodiment described here in connection with FIGS. 1A-1C and 2 where the vDAS 100 is configured to use an O-RAN fronthaul interface for communications between the vMU 112 and the APs 114, the APs 114 are configured for use with, and to expect, fronthaul data formatted in accordance with the O-RAN fronthaul interface. In such an example, if the downlink base station data provided from the physical donor interface 126 to the vMU 112 is not already formatted in accordance with the O-RAN fronthaul interface, the vMU 112 re-formats and converts the downlink base station data so that the downlink transport data communicated to the APs 114 in the simulcast zone of the base station 124 is formatted in accordance with the O-RAN fronthaul interface used by the APs 114.

As noted above, in some implementations, the content of the transport data and the manner it is generated depend on the functional split and/or fronthaul interface used to couple the associated base station 124 to the vDAS 100 and, in other implementations, the content of the transport data and the manner in which it is generated is generally the same for all donor base stations 124, regardless of the functional split and/or fronthaul interface used to couple each donor base station 124 to the vDAS 100.

In those implementations where both the content of the transport data and the manner in which it is generated depend on the functional split and/or fronthaul interface used to couple the associated base station 124 to the vDAS 100, if the base station 124 comprises a DU or BBU that is coupled to the vDAS 100 using a functional split 7-2, the downlink transport data that is communicated between the vMU 112 and the APs 114 in the base station's simulcast zone comprises frequency-domain user-plane data and associated control-plane data for each antenna port of the base station 124. In such implementations, if a base station 124 comprises a DU or BBU that is coupled to the vDAS 100 using functional split 8 or where a base station 124 comprises a “complete” base station that is coupled to the vDAS 100 using an analog RF interface, the downlink transport data that is communicated between the vMU 112 and the APs 114 in the base station's simulcast zone comprises time-domain user-plane data and associated control-plane data for each antenna port of the base station 124.

In one example of an implementation where the content of the downlink transport data and the manner in which it is generated is generally the same for all donor base stations 124, regardless of the functional split and/or fronthaul interface used to couple each donor base station 124 to the vDAS 100, all downlink transport data is generated in accordance with a functional split 7-2 where the corresponding user-plane data is communicated as frequency-domain user-plane data. For example, where a base station 124 comprises a DU or BBU that is coupled to the vDAS 100 using functional split 8 or where a base station 124 comprises a “complete” base station that is coupled to the vDAS 100 using an analog RF interface, the downlink base station data for the base station 124 comprises time-domain user-plane data for each antenna port of the base station 124 and the vMU 112 converts it to frequency-domain user-plane data and generates associated control-plane data in connection with generating the downlink transport data that is communicated between each vMU 112 and each AP 114 in the base station's simulcast zone. This can be done in order to reduce the amount of bandwidth used to transport such downlink transport data over the fronthaul network 120 (relative to communicating such user-plane data as time-domain user-plane data).

Each of the APs 114 associated with the base station 124 receives the downlink transport data, generates a respective set of downlink analog RF signals using the downlink transport data, and wirelessly transmits the respective set of analog RF signals from the respective set of coverage antennas 116 associated with each such AP 114.

Where multicast addresses and/or VLANs are used for transmitting the downlink transport data to the APs 114 in a base station's simulcast zone, each AP 114 in the simulcast zone will receive the downlink transport data transmitted by the vMU 112 using that multicast address and/or VLAN.

Where downlink transport data is broadcast to all APs 114 of the vDAS 100 and the downlink transport data includes a bitmap field to indicate which APs 114 the data is intended for, all APs 114 for the vDAS 100 will receive the downlink transport data transmitted by the vMU 112 for a base station 124 but the bitmap field will be populated with data in which only the bit positions associated with the APs 114 in the base station's simulcast zone will be set to the bit value indicating that the data is intended for them and the bit positions associated with the other APs 114 will be set to the bit value indicating that the data is not intended for them. As a result, only those APs 114 in the base station's simulcast zone will fully process such downlink transport data and the other APs 114 will discard the data after determining that it is not intended for them.

As noted above, how each AP 114 generates the set of downlink analog RF signals using the downlink transport data depends on the functional split used for communicating transport data between the vMUs 112 and the APs 114. For example, where the downlink transport data that is communicated between the vMU 112 and the APs 114 in the base station's simulcast zone comprises frequency-domain user-plane data and associated control-plane data for each antenna port of the base station 124, a RU entity implemented by each AP 114 is configured to perform the low physical layer baseband processing and RF functions for each antenna port of the base station 124 using the respective downlink transport data. This is done in order to generate a corresponding downlink RF signal for wireless transmission from a respective coverage antenna 116 associated with that AP 114. Where the downlink transport data that is communicated between the vMU 112 and the APs 114 in the base station's simulcast zone comprises time-domain user-plane data and associated control-plane data for each antenna port of the base station 124, a RU entity implemented by each AP 114 is configured to perform the RF functions for each antenna port of the base station 124 using the respective downlink transport data. This is done in order to generate a corresponding downlink RF signal for wireless transmission from a respective coverage antenna 116 associated with that AP 114.

In the uplink direction, each AP 114 included in the simulcast zone of a given base station 124 wirelessly receives a respective set of uplink RF analog signals (including the various physical channels and associated sub carriers) via the set of coverage antennas 116 associated with that AP 114, generates uplink transport data from the received uplink RF analog signals, and communicates the uplink transport data from each AP 114 over the fronthaul network 120 of the vDAS 100. The uplink transport data is communicated over the fronthaul network 120 to the vMU 112 coupled to the base station 124.

As noted above, how each AP 114 generates the uplink transport data from the set of uplink analog RF signals depends on the functional split used for communicating transport data between the vMUs 112 and the APs 114. Where the uplink transport data that is communicated between each AP 114 in the base station's simulcast zone and the serving vMU 112 comprises frequency-domain user-plane data for each antenna port of the base station 124, an RU entity implemented by each AP 114 is configured to perform the RF functions and low physical layer baseband processing for each antenna port of the base station 124 using the respective uplink analog RF signal. This is done in order to generate the corresponding uplink transport data for transmission over the fronthaul network 120 to the serving vMU 112. Where the uplink transport data that is communicated between each AP 114 in the base station's simulcast zone and the serving vMU 112 comprises time-domain user-plane data for each antenna port of the base station 124, an RU entity implemented by each AP 114 is configured to perform the RF functions for each antenna port of the base station 124 using the respective uplink analog RF signal. This is done in order to generate the corresponding uplink transport data for transmission over the fronthaul network 120 to the serving vMU 112.

The vMU 112 coupled to the base station 124 receive uplink transport data derived from the uplink transport data transmitted from the APs 114 in the simulcast zone of the base station 124, generates uplink base station data from the received uplink transport data, and provides the uplink base station data to the physical donor interface 126 coupled to the base station 124. The physical donor interface 126 coupled to the base station 124 generates one or more uplink base station signals from the uplink base station data and transmits the one or more uplink base station signals to the base station 124. As described above, the uplink transport data can be communicated from the APs 114 in the simulcast zone of the base station 124 to the vMU 112 coupled to the base station 124 via one or more intermediary units of the vDAS 100 (such as one or more ICNs or daisy-chained APs 114).

As described above, a single set of uplink base station signals are produced for each donor base station 124 using a combining or summing process that uses inputs derived from the uplink RF signals received via the coverage antennas 116 associated with the multiple APs 114 in that base station's simulcast zone, where the resulting final single set of uplink base station signals is provided to the base station 124. Also, as noted above, this combining or summing process can be performed in a centralized manner in which the combining or summing process for each base station 124 is performed by a single unit of the vDAS 100 (for example, by the associated vMU 112). This combining or summing process can also be performed for each base station 124 in a distributed or hierarchical manner in which the combining or summing process is performed by multiple units of the vDAS 100 (for example, the associated vMU 112 and one or more ICNs and/or APs 114).

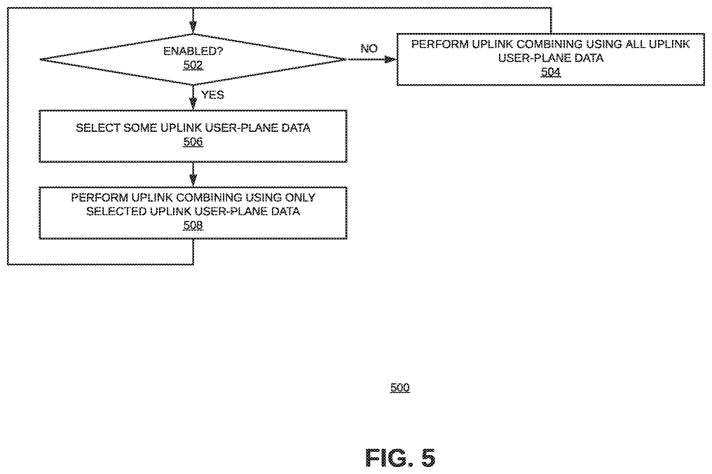

How the corresponding user-plane data is combined or summed depends on the functional split used for communicating transport data between the vMUs 112 and the APs 114 and can be performed as described below in connection with FIG. 5.

The form that the uplink base station signals take and how the uplink base station signals are generated from the uplink base station data also depend on how the base station 124 is coupled to the vDAS 100.

For example, where an Ethernet-based fronthaul interface is used (such as O-RAN, eCPRI, or RoE) to couple the base station 124 to the vDAS 100, the vMU 112 is configured to format the uplink base station data into messages formatted in accordance with the associated Ethernet-based fronthaul interface. The messages are provided to the associated physical Ethernet donor interface 142. The physical Ethernet donor interface 142 generates Ethernet packets for communicating the provided messages to the base station 124 via one or more Ethernet ports of that physical Ethernet donor interface 142. That is, in this example, the “uplink base station signals” comprise the physical-layer signals used to communicate such Ethernet packets.

Where a CPRI-based fronthaul interface is used for communications between the physical donor interface 126 and the base station 124, in one implementation, the uplink base station data comprises the various information flows that are multiplexed together in uplink CPRI frames or messages and the vMU 112 is configured to generate these various information flows in accordance with the CPRI fronthaul interface. In such an implementation, the information flows are provided to the associated physical CPRI donor interface 138. The physical CPRI donor interface 138 uses these information flows to generate CPRI frames for communicating to the base station 124 via one or more CPRI ports of that physical CPRI donor interface 138. That is, in this example, the “uplink base station signals” comprise the physical-layer signals used to communicate such CPRI frames. Alternatively, in another implementation, the uplink base station data comprises CPRI frames or messages, which the VMU 112 is configured to produce and provide to the associated physical CPRI donor interface 138 for use in producing the physical-layer signals used to communicate the CPRI frames to the base station 124.

Where an analog RF interface is used for communications between the physical donor interface 126 and the base station 124, the vMU 112 is configured to provide the uplink base station data (comprising the combined (that is, digitally summed) time-domain baseband IQ data for each antenna port of the base station 124) to the associated physical RF donor interface 134. The physical RF donor interface 134 uses the provided uplink base station data to generate an uplink analog RF signal for each antenna port of the base station 124 (for example, by performing a digital up conversion and digital-to-analog (DAC) process). For each antenna port of the base station 124, the physical RF donor interface 134 outputs the respective uplink analog RF signal (including the various physical channels and associated sub carriers) to that antenna port using the appropriate RF port of the physical RF donor interface 134. That is, in this example, the “uplink base station signals” comprise the uplink analog RF signals output by the physical RF donor interface 134.

By implementing one or more nodes or functions of a traditional DAS (such as a CAN or TEN) using, or as, one or more VNFs 102 executing on one or more physical server computers 104, such nodes or functions can be implemented using COTS servers (for example, COTS servers of the type deployed in data centers or “clouds” maintained by enterprises, communication service providers, or cloud services providers) instead of custom, dedicated hardware. As a result, such nodes and functions can be deployed more cheaply and in a more scalable manner (for example, additional capacity can be added by instantiating additional VNFs 102 as needed). This is the case even if an additional physical server computer 104 is needed in order to instantiate a new vMU 112 or ICN because such physical server computers 104 are either already available in such deployments or can be easily added at a low cost (for example, because of the COTS nature of such hardware). Also, as noted above, this approach is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100).

Other embodiments can be implemented in other ways.

For example, FIGS. 3A-3D illustrates one such embodiment.

FIGS. 3A-3D are block diagrams illustrating one exemplary embodiment of vDAS 300 in which at least some of the APs 314 are coupled to one or more vMU 112 serving them via one or more intermediate combining nodes (ICNs) 302. Each ICN 302 comprises at least one northbound Ethernet interface (NEI) 304 that couples the ICN 302 to Ethernet cabling used primarily for communicating with the one or more vMUs 112 and a plurality of southbound Ethernet interfaces (SEIs) 306 that couples the ICN 302 to Ethernet cabling used primarily for communicating with one or more of the plurality of APs 314.

Except as explicitly described here in connection with FIGS. 3A-3D, the vDAS 300 and the components thereof (including the vMU 112) are configured as described above. Also, except as explicitly described here in connection with FIGS. 3A-3D, each AP 314 is implemented in the same manner as the APs 114 described above.

The ICN 302 comprises one or more programmable devices 310 that execute, or are otherwise programmed or configured by, software, firmware, or configuration logic 312 in order to implement at least some of the functions described here as being performed by an ICN 302 (including, for example, any necessary physical layer (Layer 1) baseband processing). The one or more programmable devices 310 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way.

The ICN 302 can be implemented as a physical network function using dedicated, special-purpose hardware. Alternatively, the ICN 302 can be implemented as a virtual network function running on a physical server. For example, the ICN 302 can be implemented in the same manner as the vMU 112 described above in connection with FIG. 1.

As noted above, the fronthaul network 320 used for transport between each vMU 112 and the APs 114 and ICNs 302 (and the APs 314 coupled thereto) can be implemented in various ways. Various examples of how the fronthaul network 320 can be implemented are illustrated in FIGS. 3A-3D. In the example shown in FIG. 3A, the fronthaul network 320 is implemented using a switched Ethernet network 322 that is used to communicatively couple each AP 114 and each ICN 302 (and the APs 314 coupled thereto) to each vMU 112 serving that AP 114 or 314 or ICN 302.

In the example shown in FIG. 3B, the fronthaul network 320 is implemented using only point-to-point Ethernet links 123 or 323, where each AP 114 and each ICN 302 (and the APs 314 coupled thereto) is coupled to each serving vMU 112 serving it via a respective one or more point-to-point Ethernet links 123 or 323. In the example shown in FIG. 3C, the fronthaul network 320 is implemented using a combination of a switched Ethernet network 322 and point-to-point Ethernet links 123 or 323. In the example shown in FIG. 3D, a first ICN 302 has a second ICN 302 subtended from it so that some APs 314 are communicatively coupled to the first ICN 302 via the second ICN 302. Again, as noted above, it is to be understood that FIGS. 1A-1C and 3A-3D illustrate only a few examples of how the fronthaul network (and the vDAS more generally) can be implemented and that other variations are possible.

In one implementation, each vMU 112 that serves the ICN 302 treats the ICN 302 as one or more “virtual APs” to which it sends downlink transport data for one or more base stations 124, and from which it receives uplink transport data, for the one or more base stations 124. The ICN 302 forwards the downlink transport data to, and combines uplink transport data received from, one or more of the APs 314 coupled to the ICN 302. In one implementation of such an embodiment, the ICN 302 forwards the downlink transport data it receives for all the served base stations 124 to all of the APs 314 coupled to the ICN 302 and combines uplink transport data it receives from all of the APs 314 coupled to the ICN 302 for all of the base stations 124 served by the ICN 302.

In another implementation, the ICN 302 is configured so that a separate subset of the APs 314 coupled to that ICN 302 can be specified for each base station 124 served by that ICN 302. In such an implementation, for each base station 124 served by an ICN 302, the ICN 302 forwards the downlink transport data it receives for that base station 124 to the respective subset of the APs 314 specified for that base station 124 and combines the uplink transport data it receives from the subset of the APs 314 specified for that base station 124. That is, in this implementation, each ICN 302 can be used to forward the downlink transport data for different served base stations 124 to different subsets of APs 314 and to combine uplink transport data the ICN 302 receives from different subsets of APs 314 for different served base stations 124. Various techniques can be used to do this. For example, the ICN 302 can be configured to inspect one or more fields (or other parts) of the received transport data to identify which base station 124 the transport data is associated with. In another implementation, the ICN 302 is configured to appear as different virtual APs for different served base stations 124 and is configured to inspect one or more fields (or other parts) of the received transport data to identify which virtual AP the transport data is intended for.

In the exemplary embodiments shown in FIGS. 3A-3D, each ICN 302 is configured to use a time synchronization protocol (for example, the Institute of Electrical and Electronics Engineers (IEEE) 1588 Precision Time Protocol (PTP) or the Synchronous Ethernet (SyncE) protocol) to synchronize itself to a timing master entity established for the vDAS 300 by communicating over the switched Ethernet network 122. Each AP 314 coupled to an ICN 302 is configured to synchronize itself to the time base used in the rest of the vDAS 300 based on the synchronous Ethernet communications provided from the ICN 302.

In one example of the operation of the vDAS 300 of FIGS. 3A-3D, in the downlink direction, each ICN 302 receives downlink transport data for the base stations 124 served by that ICN 302 and communicates, using the southbound Ethernet interfaces 306 of the ICN 302, the downlink transport data to one or more of the APs 314 coupled to ICN 302. As noted above, in one implementation, each vMU 112 that is coupled to a base station 124 served by an ICN 302 treats the ICN 302 as a virtual AP and addresses downlink transport data for that base station 124 to the ICN 302, which receives it using the northbound Ethernet interface 304.

As noted above, for each served base station 124, the ICN 302 forwards the downlink transport data it receives from the serving vMU 112 for that base station 124 to one or more of the APs 314 coupled to the ICN 302. For example, as noted above, the ICN 302 can be configured to simply forward the downlink transport data it receives for all served base stations 124 to all of the APs 314 coupled to the ICN 302 or the ICN 302 can be configured so that a separate subset of the APs 314 coupled to the ICN 302 can be specified for each served base station 124, where the ICN 302 is configured to forward the downlink transport data it receives for each served base station 124 to only the specific subset of APs 314 specified for that base station 124.

Each AP 314 coupled to the ICN 302 receives the downlink transport data to it, generates respective sets of downlink analog RF signals for all base stations 124 served by the ICN 302, and wirelessly transmits the downlink analog RF signals for all of the served base stations 124 from the set of coverage antennas 116 associated with the AP 314.

Each such AP 314 generates the respective set of downlink analog RF signals for all of the base stations 124 served by the ICN 302 as described above. That is, how each AP 314 generates the set of downlink analog RF signals using the downlink transport data depends on the functional split used for communicating transport data between the vMUs 112, ICNs 302, and the APs 114 and 314. For example, where the downlink transport data comprises frequency-domain user-plane data and associated control-plane data for each antenna port of the base station 124, a RU entity implemented by each AP 314 is configured to perform the low physical layer baseband processing and RF functions for each antenna port of the base station 124 using the respective downlink transport data. This is done in order to generate a corresponding downlink RF signal for wireless transmission from a respective coverage antenna 316 associated with that AP 314. Where the downlink transport data comprises time-domain user-plane data and associated control-plane data for each antenna port of the base station 124, a RU entity implemented by each AP 314 is configured to perform the RF functions for each antenna port of the base station 124 using the respective downlink transport data. This is done in order to generate a corresponding downlink RF signal for wireless transmission from a respective coverage antenna 316 associated with that AP 314.

In the uplink direction, each AP 314 coupled to the ICN 302 that is used to serve a base station 124 receives a respective set of uplink RF analog signals (including the various physical channels and associated sub carriers) for that served base station 124. The uplink RF analog signals are received by the AP 314 via the set of coverage antennas 116 associated with that AP 314. Each such AP 314 generates respective uplink transport data from the received uplink RF analog signals for the served base station 124 and communicates, using the respective Ethernet interface 210 of the AP 314, the uplink transport data to the ICN 302.

Each such AP 314 generates the respective uplink transport data from the received uplink analog RF signals for each served base station 124 served by the AP 314 as described above. That is, how each AP 314 generates the uplink transport data from the set of uplink analog RF signals depends on the functional split used for communicating transport data between the vMUs 112, ICNs 302, and the APs 114 and 314. Where the uplink transport data comprises frequency-domain user-plane data, an RU entity implemented by each AP 314 is configured to perform the RF functions and low physical layer baseband processing for each antenna port of the base station 124 using the respective uplink analog RF signal. This is done in order to generate the corresponding uplink transport data for transmission to the ICN 302. Where the uplink transport data comprises time-domain user-plane data, an RU entity implemented by each AP 314 is configured to perform the RF functions for each antenna port of the base station 124 using the respective uplink analog RF signal. This is done in order to generate the corresponding uplink transport data for transmission to the ICN 302.

The ICN 302 receives respective uplink transport data transmitted from any subtended APs 314 or other ICNs 302. The respective uplink transport data transmitted from any subtended APs 314 and/or subtended ICNs 302 is received by the ICN 302 using the respective southbound Ethernet interfaces 306.

The ICN 302 extracts the respective uplink transport data for each served base station 124 and, for each served base station 124, combines or sums corresponding user-plane data included in the extracted uplink transport data received from the one or more subtended APs 314 and/or ICNs 302 coupled to that ICN 302 used to serve that base station 124. The manner in which each ICN 302 combines or sums the user-plane data depends on whether the user-plane data comprises time-domain data or frequency-domain data. Generally, the ICN 302 combines or sums the user-plane data in the same way that each vMU 112 does so (for example, as described below in connection with FIG. 5).

The ICN 302 generates uplink transport data for each served base station 124 that includes the respective combined user-plane data for that base station 124 and communicates the uplink transport data including combined user-plane data for each served base station 124 to the vMU 112 associated with that base station 124 or to an upstream ICN 302. In this exemplary embodiment described here in connection with FIGS. 3A-3D where the O-RAN fronthaul interface is used for communicating over the fronthaul network 120, each ICN 302 is configured to generate and format the uplink transport data in accordance with that O-RAN fronthaul interface.

The ICN 302 shown in FIGS. 3A-3D can be used to increase the number of APs 314 that can be served by each vMU 112 while reducing the processing and bandwidth load relative to directly connecting the additional APs 314 to each such vMU 112.

FIG. 4 is a block diagram illustrating one exemplary embodiment of vDAS 400 in which one or more physical donor RF interfaces 434 are configured to by-pass the vMU 112.

Except as explicitly described here in connection with FIG. 4, the vDAS 400 and the components thereof are configured as described above.

In the exemplary embodiment shown in FIG. 4, the vDAS 400 includes at least one “by-pass” physical RF donor interface 434 that is configured to bypass the vMU 112 and instead, for the base stations 124 coupled to that physical RF donor interface 434, have that physical RF donor interface 434 perform at least some of the functions described above as being performed by the vMU 112. These functions include, for the downlink direction, receiving a set of downlink RF analog signals from each base station 124 coupled to the by-pass physical RF donor interface 434, generating downlink transport data from the set of downlink RF analog signals and communicating the downlink transport data to one or more of the APs or ICNs and, in the uplink direction, receiving respective uplink transport data from one or more APs or ICNs, generating a set of uplink RF analog signals from the received uplink transport data (including performing any digital combining or summing of user-plane data), and providing the uplink RF analog signals to the appropriate base stations 124. In this exemplary embodiment, each by-pass physical RF donor interface 434 includes one or more physical Ethernet transport interfaces 448 for communicating the transport data to and from the APs 114 and ICNs. The vDAS 400 (and the by-pass physical RF donor interface 434) can be used with any of the configurations described above (including, for example, those shown in FIGS. 1A-1C and FIGS. 3A-3D).

Each by-pass physical RF donor interface 434 comprises one or more programmable devices 450 that execute, or are otherwise programmed or configured by, software, firmware, or configuration logic 452 in order to implement at least some of the functions described here as being performed by the by-pass physical RF donor interface 434 (including, for example, any necessary physical layer (Layer 1) baseband processing). The one or more programmable devices 450 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way.

The by-pass physical RF donor interface 434 can be used to reduce the overall latency associated with serving the base stations 124 coupled to that physical RF donor interface 434.

In one implementation, the by-pass physical RF donor interface 434 is configured to operate in a fully standalone mode in which the by-pass physical RF donor interface 434 performs substantially all “master unit” processing for the donor base stations 124 and APs and ICNs that it serves. For example, in such a fully standalone mode, in addition to the processing associated with generating and communicating user-plane and control-plane data over the fronthaul network 120, the by-pass physical RF donor interface 434 can also execute software that is configured to use a time synchronization protocol (for example, the IEEE 1588 PTP or SyncE protocol) to synchronize the by-pass physical RF donor interface 434 to a timing master entity established for the vDAS 100. In such a mode, the by-pass physical RF donor interface 434 can itself serve as a timing master for the APs and other nodes (for example, ICNs) served by that by-pass physical RF donor interface 434 or instead have another entity serve as a timing master for the APs and other nodes (for example, ICNs) served by that by-pass physical RF donor interface 434.

In such a fully standalone mode, the by-pass physical RF donor interface 434 can also execute software that is configured to process the downlink user-plane and/or control-plane data for each donor base station 124 in order to determine timing and system information for the donor base station 124 and associated cell (which, as described, can involve processing the downlink user-plane and/or control-plane data to perform the initial cell search processing a UE would typically perform in order to acquire time, frequency, and frame synchronization with the base station 124 and associated cell and to detect the PCI and other system information for the base station 124 and associated cell (for example, by detecting and/or decoding the PSS, the SSS, the PBCH, the MIB, and SIBs). This timing and system information for a donor base station 124 can be used, for example, to configure the operation of the by-pass physical RF donor interface 434 and/or the vDAS 100 (and the components thereof) in connection with serving that donor base station 124. In such a fully standalone mode, the by-pass physical RF donor interface 434 can also execute software that enables the by-pass physical RF donor interface 434 to exchange management-plane messages with the APs and other nodes (for example, ICNs) served by that by-pass physical RF donor interface 434 as well as with any external management entities coupled to it.

In other modes of operation, at least some of the “master unit” processing for the donor base stations 124 and APs and ICNs that the by-pass physical RF donor interface 434 serves are performed by a vMU 112. For example, the vMU 112 can serve as a timing master and the by-pass physical RF donor interface 434 can execute software that causes the by-pass physical RF donor interface 434 to serve as a timing sub-ordinate and exchange timing messages with the vMU 112 to enable the by-pass physical RF donor interface 434 to synchronize itself to the timing master. In such other modes, the by-pass physical RF donor interface 434 can itself serve as a timing master for the APs and other nodes (for example, ICNs) served by that by-pass physical RF donor interface 434 or instead have the vMU 112 (or other entity) serve as a timing master for the APs and other nodes (for example, ICNs) served by that by-pass physical RF donor interface 434. In such other modes, the vMU 112 can also execute software that is configured to process the downlink user-plane and/or control-plane data for each donor base station 124 served by the by-pass physical RF donor interface 434 in order to determine timing and system information for the donor base station 124 and associated cell. In connection with doing this, the by-pass physical RF donor interface 434 provides the required downlink user-plane and/or control-plane data to the vMU 112. In such other modes, the vMU 112 can also execute software that enables it to exchange management-plane messages with the by-pass physical RF donor interface 434 and the APs and other nodes (for example, ICNs) served by the by-pass physical RF donor interface 434 as well as with any external management entities coupled to it. In such other modes, data or messages can be communicated between the by-pass physical RF donor interface 434 and the vMU 112, for example, over the fronthaul switched Ethernet network 122 (which is suitable if the by-pass physical RF donor interface 434 is physically separate from the physical server computer 104 used to execute the vMU 112) or over a PCIe lane to a CPU used to execute the vMU 112 (which is suitable if the by-pass physical RF donor interface 434 is implemented as a card inserted into a slot of the physical server computer 104 used to execute the vMU 112).

The by-pass physical RF donor interface 434 can be configured and used in other ways.

As noted above, various entities in the vDAS 100, 300, or 400 combine or sum uplink data. For example, in the exemplary embodiment described above in connection with FIG. 1, as a part of generating the uplink base station data for each uplink antenna port of a base station 124, the corresponding vMU 112 combines or sums corresponding user-plane data included in the uplink transport data received from APs 114 in the base station's simulcast zone. In the exemplary embodiment described above in connection with FIG. 3, each ICN 302 also performs uplink combining or summing in the same general manner that the vMU 112 does. Also, in the exemplary embodiment described above in connection with FIG. 4, each physical donor RF interface 434 that is configured to by-pass the vMU 112 also performs uplink combining or summing in the same general manner that the vMU 112 does. Moreover, any daisy-chained also performs uplink combining or summing.

In the following description, an entity that is configured to perform uplink combining or summing is also referred to as a “combining entity,” and each entity that is subtended from a combining entity and that transmits uplink transport data to the combining entity is also referred to here as a “source entity” for that combining entity. That is, a distributed antenna system serving a base station can be considered to comprise at least one combining entity and a plurality of source entities communicatively coupled to the combining entity and configured to source uplink data for the base station to the combining entity. Also, the combining entity can be considered a source entity for itself in those situations where the combining entity is configured to receive uplink RF signals via coverage antennas 116 associated with it (for example, where the combining entity is a “daisy-chained” AP 114).

One approach to performing uplink combining or summing that reduces uplink noise and/or improves the signal-to-interference-and-noise ratio (SINR) in such an embodiment is described below in connection with FIG. 5.

FIG. 5 comprises a high-level flowchart illustrating one exemplary embodiment of a method 500 of performing uplink combining in a distributed antenna system. The embodiment of method 500 shown in FIG. 5 is described here as being implemented using the vDASs 100, 300, and 400 described above. However, it is to be understood that other embodiments can be implemented in other ways. For example, the uplink combining techniques described here can be used in a non-virtualized DAS.

The blocks of the flow diagram shown in FIG. 5 have been arranged in a generally sequential manner for ease of explanation; however, it is to be understood that this arrangement is merely exemplary, and it should be recognized that the processing associated with method 500 (and the blocks shown in FIG. 5) can occur in a different order (for example, where at least some of the processing associated with the blocks is performed in parallel and/or in an event-driven manner). Also, most standard exception handling is not described for ease of explanation; however, it is to be understood that method 500 can and typically would include such exception handling. Moreover, one or more aspects of method 500 can be configurable or adaptive (either manually or in an automated manner).

Method 500 includes determining if selection combining is enabled (block 502). If selection combining is not enabled, uplink combining is performed using uplink user-plane data sourced from all of the source entities for the base station 124 (block 504). In some examples, the combining is performed by digitally summing corresponding uplink user-plane data sourced from all of the source entities for the base station 124 (for example, as described below in connection with block 508 except that the uplink data that is summed is sourced from all of the source entities for the base station 124). In other examples, the combining is performed in other ways (for example, using proportional fairness combining, interference rejection combining, maximal-ratio combining, equal-gain combining, or similar techniques, where the input uplink user-plane data is sourced from all of the source entities for the base station 124).

In the exemplary embodiment described here in connection with FIG. 5, selection combining can be selectively enabled or disabled. For example, in some implementations, selection combining is performed in accordance with a duty cycle, where selection combining is performed for a portion of each cycle and is not performed for the remaining or other portion of each cycle. For example, in one such implementation, selection combining is performed 90% of each cycle and no selection combining is performed for the other 10% of each cycle. While the selection combining described below reduces uplink noise and/or improves SINR, it is possible that the selection combining may result in all uplink user-plane data for some UEs 118 being excluded from the combining operation (for example, because the UE 118 is located relatively far from all APs 114 in the associated base station's simulcast zone). As result of performing selection combining, the base station 124 will not be able to receive transmissions from such fully excluded UEs 118. However, when selection combining is not being performed, uplink user-plane data from all the source entities is combined and the total exclusion of uplink user-plane data for such UEs 118 can be avoided, thereby providing such UEs 118 with an opportunity for the base station 124 to receive transmissions from those UEs 118.

The vDAS 100, 300, or 400 can be configured to dynamically disable selection combining on a real-time basis under the control of the corresponding base station 124. For example, in one such implementation, the vDAS 100, 300, or 400 and each served base station 124 are able to exchange management-plane data using an Ethernet connection established between the vDAS 100, 300, or 400 and the base station 124 (for example, an Ethernet connection established using one of the physical donor Ethernet interfaces 142 or physical transport Ethernet interfaces 146). In such an implementation, the base station 124 can be configured to identify any UEs 118 that are having all their uplink user-plane data excluded from the uplink combining process when selection combining is being used and disable selection combining while such UEs 118 are transmitting uplink data to the base station 124.

Method 500 comprises, if selection combining is enabled, selecting some of the uplink user-plane data sourced from the source entities for the base station (block 506) and performing uplink combining using only the selected uplink user-plane data to generate the combined uplink user-plane data for the base station (block 508).

The resulting combined uplink user-plane data can then be used, for example, to generate the uplink base station data for the associated uplink antenna port of the base station 124 (for example, where the combining entity comprises a vMU 112 or a physical donor RF interface 434 that is configured to by-pass the vMU 112) or to generate uplink transport data for the associated uplink antenna port of the base station 124 to be communicated to another combining entity (for example, where the combining entity comprises an ICN 302 or a daisy-chained AP 114).

How the user-plane uplink data is selected and combined depends on the functional split used for communicating uplink transport data between the combining entity and the various source entities sourcing uplink data to the combining entity.

Where the uplink transport data communicated between each source entity and the combining entity comprises frequency-domain baseband IQ data, the combining entity is configured to extract, from the uplink transport data received from each source entity, the respective frequency-domain baseband IQ data for each uplink antenna port of the base station 124 and select frequency-domain baseband IQ data for combining on a resource-block-by-resource-block basis.

For example, in some implementations, for each resource block, the frequency-domain baseband IQ data that is received from each source entity for that resource block is used to calculate a signal strength metric (for example, a received signal strength indicator calculated over the various resource elements of that resource block) and the signal strength metric is compared to a threshold. If the signal strength metric exceeds the threshold, the corresponding frequency-domain baseband IQ data is selected for combining. The combining is then performed by digitally summing all of the selected frequency-domain baseband IQ data for that resource block on a resource-element-by-resource-element basis.

In another implementation, for each resource block, the frequency-domain baseband IQ data that is received from each source entity for that resource block is used to calculate a signal strength metric (for example, a received signal strength indicator calculated over the various resource elements of that resource block) and the signal strength metrics for all of the source entities are sorted from strongest to weakest. Then, the corresponding frequency-domain baseband IQ data source from a predetermined number of source entities having the strongest signal strength metrics is selected for combining. The combining is then performed by digitally summing all of the selected frequency-domain baseband IQ data for that resource block on a resource-element-by-resource-element basis.

Where the uplink transport data communicated between each source entity and the combining entity comprises time-domain baseband IQ data, the combining entity is configured to extract, from the uplink transport data received from each source entity, the respective time-domain baseband IQ data for each uplink antenna port of the base station 124 and select time-domain baseband IQ data for combining on a resource-block-by-resource-block basis.

For example, in one such implementation, for each resource block, the time-domain baseband IQ data that is received from each source entity for that resource block is used to calculate a signal strength metric (for example, a received signal strength indicator calculated over the IQ data for that resource block) and the signal strength metric is compared to a threshold. If the signal strength metric exceeds the threshold, the corresponding time-domain baseband IQ data is selected for combining. The combining is then performed by digitally summing all of the selected time-domain baseband IQ data for that resource block on a sample-by-sample basis.

In another implementation, for each resource block, the time-domain baseband IQ data that is received from each source entity for that resource block is used to calculate a signal strength metric (for example, a received signal strength indicator calculated over the IQ data for that resource block) and the signal strength metrics for all of the source entities are sorted from strongest to weakest. Then, the corresponding time-domain baseband IQ data from a predetermined number of source entities having the strongest signal strength metrics is selected for combining. The combining is then performed by digitally summing all of the selected time-domain baseband IQ data for that resource block on a sample-by-sample basis.

In some implementations, the selection and combining are both performed in the combining entity.

In other implementations, the selection is performed in each source entity so that the source entity only transmits the uplink data to the combining entity if the corresponding uplink user-plane data is selected for combining and does not transmit the uplink data to the combining entity if the corresponding uplink user-plane data is not selected for combining. These implementations will tend to reduce the amount of transport data transmitted over the front haul of the vDAS 100, 300, or 400. These implementations, for example, can use the threshold-based selection techniques described above.

The selection of uplink user-plane data and/or the combining of the selected uplink user-plane data can be performed in other ways. For example, if some APs 114 are located closer to a dominant macro base station and would otherwise tend to primarily contribute only “interference” to the combined uplink user-plane data, uplink user-plane data sourced from such APs 114 can be excluded from the combining process (that is, such uplink user-plane data is not selected for combining). Also, the combining of the selected uplink user-plane data can be performed using other combining techniques such as proportional fairness combining, interference rejection combining, maximal-ratio combining, equal-gain combining, or similar techniques, where the input uplink user-plane data for combining comprises only the selected uplink user-plane data.

By using the selection combining processing of method 500, uplink user-plane data that comprises mostly “noise” (and does not comprise any meaningful “signal”) can be excluded from the uplink combining process, which will tend to reduce the amount of noise in, and the corresponding noise floor of, the resulting combined uplink user-plane data. Also, the selection combining processing of method 500 can reduce the amount of “interference” in the resulting combined uplink user-plane data by excluding uplink user-plane data that would otherwise tend to contribute primarily “interference” to the combining process. Also, performing uplink combining using uplink user-plane data sourced from multiple APs 114 (especially where the uplink user-plane data used contributes primarily “signal” to the combined uplink user-plane data) will tend to improve the signal quality of the resulting combined uplink user-plane data. As a result, the overall SINR of the combined uplink user-plane data will tend to be improved.

Information associated with performing method 500 can be used in other ways. For example, information associated with performing method 500 can be used to determine which source entities are inactive for a given base station 124 and to disable communicating downlink transport to source entities that are considered inactive for the base station 124.

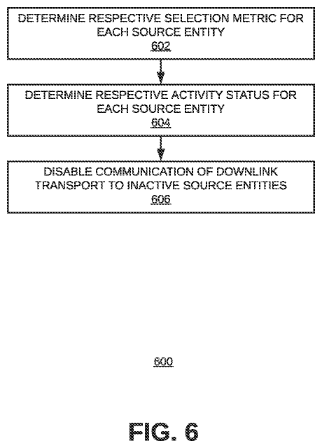

One approach to doing this is described below in connection with FIG. 6.

FIG. 6 comprises a high-level flowchart illustrating one exemplary embodiment of a method 600 of identifying and disabling downlink transport to inactive source entities of a distributed antenna system. The embodiment of method 600 shown in FIG. 6 is described here as being implemented using the vDASs 100, 300, and 400 described above. However, it is to be understood that other embodiments can be implemented in other ways. For example, method 600 can be used in a non-virtualized DAS.

The blocks of the flow diagram shown in FIG. 6 have been arranged in a generally sequential manner for ease of explanation; however, it is to be understood that this arrangement is merely exemplary, and it should be recognized that the processing associated with method 600 (and the blocks shown in FIG. 6) can occur in a different order (for example, where at least some of the processing associated with the blocks is performed in parallel and/or in an event-driven manner). Also, most standard exception handling is not described for ease of explanation; however, it is to be understood that method 600 can and typically would include such exception handling. Moreover, one or more aspects of method 600 can be configurable or adaptive (either manually or in an automated manner).

Method 600 can be performed by a combining entity for each base station 124 served by the vDAS 100, 300, or 400.

Method 600 comprises determining a respective selection metric for each source entity that is providing uplink data to the combining entity for the base station 124 (block 602) and determining a respective activity status for each source entity sourcing uplink data to that combining entity as a function of the respective selection metric determined for that source entity (block 604). Method 600 further comprises disabling communication of downlink transport data to any source entity while the respective activity status for that source entity indicates that the source entity is inactive (block 606).

In one implementation, each combining entity can be configured to calculate, for each source entity that is providing uplink data to the combining entity for the base station 124, a running count of the number of consecutive uplink slots for which no uplink data from that source entity was used in the uplink combining performed by that combining entity. That is, in such an implementation, the selection metric comprises the respective running count of the number of consecutive uplink slots for which no uplink data from a given source entity was used in the uplink combining.

In such an implementation, a source entity can be considered to have an “inactive” status if the respective running count calculated for that source entity exceeds a predetermined threshold value and can be considered to have an “active” status if the respective running count calculated for that source entity does not exceed the predetermined threshold value. The combining entity can be configured to disable communication of downlink transport data to any source entity having inactive status while that source entity continues to have an inactive status. For any source entity for which the communication of downlink transport data has been disabled, the combining entity re-enables communication downlink transport data once the respective activity status for that source entity indicates that it is active (that is, is no longer inactive). Other embodiments can be implemented in other ways.

By disabling the communication of downlink transport data to inactive source entities, the amount of transport data transmitted over the front haul of the vDAS 100, 300, or 400 can be reduced.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### Example Embodiments

Example 1 includes a distributed antenna system serving a base station, the distributed antenna system comprising: a combining entity; and a plurality of source entities communicatively coupled to the combining entity and configured to source uplink user-plane data for the base station to the combining entity; and wherein the distributed antenna system is configured to perform selection combining by doing the following: select some of the uplink data sourced from the source entities for the base station; and perform uplink combining using only the selected uplink user-plane data to generate combined uplink user-plane data for the base station.

Example 2 includes the distributed antenna system of Example 1, wherein the distributed antenna system is configured to determine if selection combining is enabled and to perform selection combining only when the selection combining is enabled and is configured to perform uplink combining using uplink user-plane data sourced from all source entities to generate the combined uplink user-plane data for the base station when the selection combining is not enabled.

Example 3 includes the distributed antenna system of any of Examples 1-3, wherein the distributed antenna system is configured to select some of the uplink user-plane data sourced from the source entities for the base station on a resource-block-by-resource-block basis.

Example 4 includes the distributed antenna system of Example 3, wherein the distributed antenna system is configured to select some of the uplink user-plane data sourced from the source entities for the base station by, for each source entity, calculating a signal strength metric for each resource block, comparing the signal strength metric for the resource block to a threshold, and selecting the corresponding uplink user-plane data if the signal strength metric for the resource block exceeds the threshold.

Example 5 includes the distributed antenna system of any of Examples 3-4, wherein the distributed antenna system is configured to select some of the uplink user-plane data sourced from the source entities for the base station by, for each resource block, calculating a signal strength metric for each source entity, sorting the signal strength metrics for the resource block, and selecting the corresponding uplink user-plane data sourced from a predetermined number of the source entities having the strongest signal strength metrics.

Example 6 includes the distributed antenna system of any of Examples 1-5, wherein the distributed antenna system is configured to perform uplink combining using only the selected uplink user-plane data to generate combined uplink user-plane data for the base station on a resource-element-by-resource-element basis.

Example 7 includes the distributed antenna system of any of Examples 1-6, wherein the distributed antenna system is configured to perform uplink combining using only the selected uplink user-plane data to generate combined uplink user-plane data for the base station on a sample-by-sample basis.

Example 8 includes the distributed antenna system of any of Examples 1-7, wherein the uplink user-plane data comprises frequency-domain user-plane data.

Example 9 includes the distributed antenna system of any of Examples 1-8, wherein the uplink user-plane data comprises time-domain user-plane data.

Example 10 includes the distributed antenna system of any of Examples 1-9, wherein the combining entity is configured to select some of the uplink user-plane data sourced from the source entities for the base station.

Example 11 includes the distributed antenna system of any of Examples 1-10, wherein each of the source entities is configured to determine if uplink user-plane data sourced from that source entity is selected.

Example 12 includes the distributed antenna system of any of Examples 1-11, wherein the combining entity is configured to perform uplink combining using only the selected uplink user-plane data to generate combined uplink user-plane data for the base station.

Example 13 includes the distributed antenna system of any of Examples 1-12, wherein the combining entity comprises one of a master unit, an intermediate combining node, an access point, and a physical donor interface configured to by-pass the master unit; and wherein each of the source entities comprises one of an access point or the intermediate combining node.

Example 14 includes the distributed antenna system of any of Examples 1-13, wherein one of the source entities for the combining entity is the combining entity.

Example 15 includes the distributed antenna system of Example 14, wherein the combining entity comprises a set of antennas used to receive analog radio frequency for use in generating uplink user-plane data for the base station.

Example 16 includes the distributed antenna system of any of Examples 1-15, wherein the distributed antenna unit is configured to use information related to the selection of some of the uplink user-plane data sourced from the source entities for the base station to determine which source entities are inactive and disabling communication of downlink transport data to source entities that are inactive.

Example 17 includes the distributed antenna system of any of Examples 1-16, wherein the distributed antenna system comprises a virtualized distributed antenna system.

Example 18 includes the distributed antenna system of any of Examples 1-17, wherein the distributed antenna system is configured to select some of the uplink user-plane data sourced from the source entities for the base station by excluding uplink data that tends to contribute primarily interference.

Example 19 includes the distributed antenna system of any of Examples 1-18, wherein the distributed antenna system is configured to perform uplink combining using only the selected uplink user-plane data to generate combined uplink user-plane data for the base station by performing proportional fairness combining, interference rejection combining, maximal-ratio combining, equal-gain combining, or similar techniques, where the input uplink user-plane data for the combining comprises only the selected uplink user-plane data.

Example 20 includes a method of performing uplink combining in a distributed antenna system serving a base station, the distributed antenna system comprising a combining entity and a plurality of source entities communicatively coupled to the combining entity and configured to source uplink user-plane data for the base station to the combining entity, the method comprising: performing selection combining for the base station by doing the following: selecting some of the uplink user-plane data sourced from the source entities for the base station; and performing uplink combining using only the selected uplink user-plane data to generate combined uplink user-plane data for the base station.

Example 21 includes the method of Example 20, wherein the method comprises determining if selection combining is enabled and performing selection combining only when the selection combining is enabled and performing uplink combining using uplink user-plane data sourced from all source entities to generate the combined uplink user-plane data for the base station when the selection combining is not enabled.

Example 22 includes the method of any of Examples 20-21, wherein selecting some of the uplink user-plane data sourced from the source entities for the base station comprises selecting some of the uplink user-plane data sourced from the source entities for the base station on a resource-block-by-resource-block basis.

Example 23 includes the method of Example 22, wherein selecting some of the uplink user-plane data sourced from the source entities for the base station comprises, for each source entity, calculating a signal strength metric for each resource block, comparing the signal strength metric for the resource block to a threshold, and selecting the corresponding uplink user-plane data if the signal strength metric for the resource block exceeds the threshold.

Example 24 includes the method of any of Examples 22-23, wherein selecting some of the uplink user-plane data sourced from the source entities for the base station comprises, for each resource block, calculating a signal strength metric for each source entity, sorting the signal strength metrics for the resource block, and selecting the corresponding uplink user-plane data sourced from a predetermined number of the source entities having the strongest signal strength metrics.

Example 25 includes the method of any of Examples 20-24, wherein performing uplink combining using only the selected uplink user-plane data to generate the combined uplink user-plane data for the base station comprises performing uplink combining using only the selected uplink user-plane data to generate the combined uplink user-plane data for the base station on a resource-element-by-resource-element basis.

Example 26 includes the method of any of Examples 20-25, wherein performing uplink combining using only the selected uplink user-plane data to generate the combined uplink user-plane data for the base station comprises performing uplink combining using only the selected uplink user-plane data to generate the combined uplink user-plane data for the base station on a sample-by-sample basis.

Example 27 includes the method of any of Examples 20-26, wherein the uplink user-plane data comprises frequency-domain user-plane data.

Example 28 includes the method of any of Examples 20-27, wherein the uplink user-plane data comprises time-domain user-plane data.

Example 29 includes the method of any of Examples 20-28, wherein the combining entity is configured to select some of the uplink user-plane data sourced from the source entities for the base station.

Example 30 includes the method of any of Examples 20-29, wherein each of the source entities is configured to determine if uplink user-plane data sourced from that source entity is selected.

Example 31 includes the method of any of Examples 20-30, wherein the combining entity is configured to perform uplink combining using only the selected uplink user-plane data to generate combined uplink user-plane data for the base station.

Example 32 includes the method of any of Examples 20-31, wherein the combining entity comprises one of a master unit, an intermediate combining node, an access point, and a physical donor interface configured to by-pass the master unit; and wherein each of the source entities comprises one of an access point or the intermediate combining node.

Example 33 includes the method of any of Examples 20-32, wherein one of the source entities for the combining entity is the combining entity.

Example 34 includes the method of Example 33, wherein the combining entity comprises a set of antennas used to receive analog radio frequency for use in generating uplink user-plane data for the base station.

Example 35 includes the method of any of Examples 20-34, further comprises using information related to the selection of some of the uplink user-plane data sourced from the source entities for the base station to determine which source entities are inactive and disabling communication of downlink transport data to source entities that are inactive.

Example 36 includes the method of any of Examples 20-35, wherein the distributed antenna system comprises a virtualized distributed antenna system.

Example 37 includes the method of any of Examples 20-36, wherein selecting some of the uplink user-plane data sourced from the source entities for the base station comprises excluding uplink user-plane data that tends to contribute primarily interference.

Example 38 includes the method of any of Examples 20-37, wherein performing uplink combining using only the selected uplink user-plane data to generate the combined uplink user-plane data for the base station comprises performing proportional fairness combining, interference rejection combining, maximal-ratio combining, equal-gain combining, or similar techniques, where the input uplink user-plane data for the combining comprises only the selected uplink user-plane data.

What is claimed is:

1. A distributed antenna system serving a base station, the distributed antenna system comprising:
a combining entity; and
a plurality of source entities communicatively coupled to the combining entity and configured to source uplink user-plane data for the base station to the combining entity; and
wherein the distributed antenna system is configured to perform selection combining by doing the following:
select some of the uplink data sourced from the source entities for the base station; and
perform uplink combining using only the selected uplink user-plane data to generate combined uplink user-plane data for the base station.

2. The distributed antenna system of claim 1, wherein the distributed antenna system is configured to determine if selection combining is enabled and to perform selection combining only when the selection combining is enabled and is configured to perform uplink combining using uplink user-plane data sourced from all source entities to generate the combined uplink user-plane data for the base station when the selection combining is not enabled.

3. The distributed antenna system of claim 1, wherein the distributed antenna system is configured to select some of the uplink user-plane data sourced from the source entities for the base station on a resource-block-by-resource-block basis.

4. The distributed antenna system of claim 3, wherein the distributed antenna system is configured to select some of the uplink user-plane data sourced from the source entities for the base station by, for each source entity, calculating a signal strength metric for each resource block, comparing the signal strength metric for the resource block to a threshold, and selecting the corresponding uplink user-plane data if the signal strength metric for the resource block exceeds the threshold.

5. The distributed antenna system of claim 3, wherein the distributed antenna system is configured to select some of the uplink user-plane data sourced from the source entities for the base station by, for each resource block, calculating a signal strength metric for each source entity, sorting the signal strength metrics for the resource block, and selecting the corresponding uplink user-plane data sourced from a predetermined number of the source entities having the strongest signal strength metrics.

6. The distributed antenna system of claim 1, wherein the distributed antenna system is configured to perform uplink combining using only the selected uplink user-plane data to generate combined uplink user-plane data for the base station on a resource-element-by-resource-element basis.

7. The distributed antenna system of claim 1, wherein the distributed antenna system is configured to perform uplink combining using only the selected uplink user-plane data to generate combined uplink user-plane data for the base station on a sample-by-sample basis.

8. The distributed antenna system of claim 1, wherein the uplink user-plane data comprises frequency-domain user-plane data.

9. The distributed antenna system of claim 1, wherein the uplink user-plane data comprises time-domain user-plane data.

10. The distributed antenna system of claim 1, wherein the combining entity is configured to select some of the uplink user-plane data sourced from the source entities for the base station.

11. The distributed antenna system of claim 1, wherein each of the source entities is configured to determine if uplink user-plane data sourced from that source entity is selected.

12. The distributed antenna system of claim 1, wherein the combining entity is configured to perform uplink combining using only the selected uplink user-plane data to generate combined uplink user-plane data for the base station.

13. The distributed antenna system of claim 1, wherein the combining entity comprises one of a master unit, an intermediate combining node, an access point, and a physical donor interface configured to by-pass the master unit; and
wherein each of the source entities comprises one of an access point or the intermediate combining node.

14. The distributed antenna system of claim 1, wherein one of the source entities for the combining entity is the combining entity.

15. The distributed antenna system of claim 14, wherein the combining entity comprises a set of antennas used to receive analog radio frequency for use in generating uplink user-plane data for the base station.

16. The distributed antenna system of claim 1, wherein the distributed antenna unit is configured to use information related to the selection of some of the uplink user-plane data sourced from the source entities for the base station to determine which source entities are inactive and disabling communication of downlink transport data to source entities that are inactive.

17. The distributed antenna system of claim 1, wherein the distributed antenna system comprises a virtualized distributed antenna system.

18. The distributed antenna system of claim 1, wherein the distributed antenna system is configured to select some of the uplink user-plane data sourced from the source entities for the base station by excluding uplink data that tends to contribute primarily interference.

19. The distributed antenna system of claim 1, wherein the distributed antenna system is configured to perform uplink combining using only the selected uplink user-plane data to generate combined uplink user-plane data for the base station by performing proportional fairness combining, interference rejection combining, maximal-ratio combining, equal-gain combining, or similar techniques, where the input uplink user-plane data for the combining comprises only the selected uplink user-plane data.

20. A method of performing uplink combining in a distributed antenna system serving a base station, the distributed antenna system comprising a combining entity and a plurality of source entities communicatively coupled to the combining entity and configured to source uplink user-plane data for the base station to the combining entity, the method comprising:
performing selection combining for the base station by doing the following:
selecting some of the uplink user-plane data sourced from the source entities for the base station; and
performing uplink combining using only the selected uplink user-plane data to generate combined uplink user-plane data for the base station.

21. The method of claim 20, wherein the method comprises determining if selection combining is enabled and performing selection combining only when the selection combining is enabled and performing uplink combining using uplink user-plane data sourced from all source entities to generate the combined uplink user-plane data for the base station when the selection combining is not enabled.

22. The method of claim 20, wherein selecting some of the uplink user-plane data sourced from the source entities for the base station comprises selecting some of the uplink user-plane data sourced from the source entities for the base station on a resource-block-by-resource-block basis.

23. The method of claim 22, wherein selecting some of the uplink user-plane data sourced from the source entities for the base station comprises, for each source entity, calculating a signal strength metric for each resource block, comparing the signal strength metric for the resource block to a threshold, and selecting the corresponding uplink user-plane data if the signal strength metric for the resource block exceeds the threshold.

24. The method of claim 22, wherein selecting some of the uplink user-plane data sourced from the source entities for the base station comprises, for each resource block, calculating a signal strength metric for each source entity, sorting the signal strength metrics for the resource block, and selecting the corresponding uplink user-plane data sourced from a predetermined number of the source entities having the strongest signal strength metrics.

25. The method of claim 20, wherein performing uplink combining using only the selected uplink user-plane data to generate the combined uplink user-plane data for the base station comprises performing uplink combining using only the selected uplink user-plane data to generate the combined uplink user-plane data for the base station on a resource-element-by-resource-element basis.

26. The method of claim 20, wherein performing uplink combining using only the selected uplink user-plane data to generate the combined uplink user-plane data for the base station comprises performing uplink combining using only the selected uplink user-plane data to generate the combined uplink user-plane data for the base station on a sample-by-sample basis.

27. The method of claim 20, wherein the uplink user-plane data comprises frequency-domain user-plane data.

28. The method of claim 20, wherein the uplink user-plane data comprises time-domain user-plane data.

29. The method of claim 20, wherein the combining entity is configured to select some of the uplink user-plane data sourced from the source entities for the base station.

30. The method of claim 20, wherein each of the source entities is configured to determine if uplink user-plane data sourced from that source entity is selected.

31. The method of claim 20, wherein the combining entity is configured to perform uplink combining using only the selected uplink user-plane data to generate combined uplink user-plane data for the base station.

32. The method of claim 20, wherein the combining entity comprises one of a master unit, an intermediate combining node, an access point, and a physical donor interface configured to by-pass the master unit; and
wherein each of the source entities comprises one of an access point or the intermediate combining node.

33. The method of claim 20, wherein one of the source entities for the combining entity is the combining entity.

34. The method of claim 33, wherein the combining entity comprises a set of antennas used to receive analog radio frequency for use in generating uplink user-plane data for the base station.

35. The method of claim 20, further comprises using information related to the selection of some of the uplink user-plane data sourced from the source entities for the base station to determine which source entities are inactive and disabling communication of downlink transport data to source entities that are inactive.

36. The method of claim 20, wherein the distributed antenna system comprises a virtualized distributed antenna system.

37. The method of claim 20, wherein selecting some of the uplink user-plane data sourced from the source entities for the base station comprises excluding uplink user-plane data that tends to contribute primarily interference.

38. The method of claim 20, wherein performing uplink combining using only the selected uplink user-plane data to generate the combined uplink user-plane data for the base station comprises performing proportional fairness combining, interference rejection combining, maximal-ratio combining, equal-gain combining, or similar techniques, where the input uplink user-plane data for the combining comprises only the selected uplink user-plane data.
